(19) United States
(12) Patent Application Publication
(10) Pub. No.: US 2026/0035586 A1
(43) Pub. Date: Feb. 5, 2026

(54) INK SET, FLUID APPLYING METHOD, AND FLUID APPLYING APPARATUS

(71) Applicants: Hiroki KOBAYASHI, Kanagawa (JP); Tomohiro Nakagawa, Kanagawa (JP); Daiki Hyakutake, Kanagawa (JP)

(72) Inventors: Hiroki KOBAYASHI, Kanagawa (JP); Tomohiro Nakagawa, Kanagawa (JP); Daiki Hyakutake, Kanagawa (JP)

(73) Assignee: Ricoh Company, Ltd., Tokyo (JP)

(21) Appl. No.: 19/289,775

(22) Filed: Aug. 4, 2025

(30) Foreign Application Priority Data
Aug. 5, 2024 (JP) 2024-129066

(51) Int. Cl. C09D 11/54; B41J 2/165; B41J 11/00; B41M 5/00; B41M 7/00; C09D 11/102; C09D 11/38; C09D 11/40

(52) U.S. Cl. CPC C09D 11/54; B41J 2/16535; B41J 11/0024; B41M 5/0011; B41M 7/009; C09D 11/102; C09D 11/38; C09D 11/40; B41J 2002/1655; B41P 2235/24

(57) ABSTRACT

An ink set contains an aqueous pigment ink, a pre-treatment fluid A containing an amino-modified silicone, and a pre-treatment fluid B containing a water-soluble amine and an organic acid,
wherein the following relationship is satisfied:

$$0.08 \leq b / a \leq 1.00 ,$$

where a represents a total moles of acid groups of the organic acid in the pre-treatment fluid B and b represents a total moles of amino groups of the organic acid in the pre-treatment fluid B, wherein the pre-treatment fluid A contains no organic acid.

### CROSS-REFERENCE TO RELATED APPLICATIONS

This patent application is based on and claims priority pursuant to 35 U.S.C. § 119 to Japanese Patent Application No. 2024-129066, filed on Aug. 5, 2024, in the Japan Patent Office, the entire disclosure of which is hereby incorporated by reference herein.

### BACKGROUND

### Technical Field

The present disclosure is related to an ink set, a fluid applying method, and a fluid applying apparatus.

### Description of the Related Art

The inkjet printing method has rapidly gained popularity in recent years due to its ability to easily reproduce color images and its low running costs. This method is also beginning to spread into the textile printing field, which has traditionally relied on analog techniques centered around dyes. In particular, the use of aqueous pigment inks—where pigments serve as the coloring material-enables a significant reduction in industrial wastewater generated by textile printing. Combined with inventory reduction enabled by on-demand inkjet printing, it is now recognized as an environmentally friendly printing technique.

### SUMMARY

The present disclosure described herein provides an ink set which contains an aqueous pigment ink, a pre-treatment fluid A containing an amino-modified silicone and a pre-treatment fluid B containing a water-soluble amine and an organic acid, wherein the following relationship is satisfied: 0.08≤b/a≤1.00, where a represents a total moles of acid groups of the organic acid in the pre-treatment fluid B and b represents a total moles of amino groups of the organic acid in the pre-treatment fluid B, and wherein the pre-treatment fluid A contains no organic acid.

As another aspect of the present disclosure, a fluid applying method is provided which includes applying pre-treatment fluids containing separately the pre-treatment fluid A and the pre-treatment fluid B of the ink set mentioned above to a substrate, and applying the aqueous pigment ink of the ink set to the substrate.

As another aspect of the present disclosure, a fluid applying apparatus is provided which includes a pre-treatment fluid applying device to apply the pre-treatment fluid A and the pre-treatment fluid B of the ink set mentioned above to a substrate, and an ink applying device to apply the aqueous pigment ink of the ink set mentioned above.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating a printing apparatus;

FIG. 2 is a flowchart illustrating an example of the operation of the apparatus illustrated in FIG. 1;

FIG. 3 is a schematic diagram illustrating an example of the control device of the printing apparatus illustrated in FIG. 1;

FIG. 4 is a schematic diagram for explaining another example of the printing apparatus;

FIG. 5 is a schematic diagram illustrating a printing apparatus;

FIG. 6 is a diagram illustrating a perspective view of the tank;

FIG. 7 is a schematic plan view of another example of the printing apparatus;

FIG. 8 is a schematic diagram illustrating an example of an inkjet printing apparatus;

FIG. 9 is a schematic diagram illustrating an example of the block chart of the function of the printing apparatus;

FIGS. 10A and 10B are plan views illustrating an example of the wiping unit constituting the nozzle surface cleaning device;

FIGS. 11A and 11B are schematic views of another example of the nozzle surface cleaning deice;

FIGS. 12A to 12D are schematic views of another example of the nozzle surface cleaning deice;

FIGS. 13A to 13D are schematic views of another example of the nozzle surface cleaning deice;

FIG. 14 is a schematic view illustrating an example of the electrode manufacturing device; and

FIG. 15 is a diagram illustrating a nozzle surface and nozzles of a fluid applying apparatus.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

The present disclosure described herein provides an ink set which minimizes deterioration in the texture of fabric caused by inkjet printing with an aqueous pigment ink, exhibits excellent storage stability, and further reduces the likelihood of degradation of liquid-contact components in the inkjet printing apparatus

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### Ink Set

The ink set of the present disclosure includes an aqueous pigment ink, pre-treatment fluid A, and pre-treatment fluid B, and may further optionally include other fluids such as a post-treatment fluid.

### Aqueous Pigment Ink

The following describes the organic solvents, water, pigments, resins, additives, and other components used in the aqueous pigment ink (hereinafter also may simply referred to as ink).

### Organic Solvent

There is no specific limitation to the organic solvent for use in the present disclosure. For example, a water-soluble organic solvent can be used. It includes, but is not limited to, polyhydric alcohols, ethers such as polyhydric alcohol alkylethers and polyhydric alcohol arylethers, nitrogen-containing heterocyclic compounds, amides, amines, and sulfur-containing compounds.

Specific examples of the water-soluble organic solvents include, but are not limited to, polyols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, and petriol; polyol alkylethers such as ethylene glycol monoethylether, ethylene glycol monobutyl ether, diethylene glycol monomethylether, diethylene glycol monoethylether, diethylene glycol monobutyl ether, tetraethylene glycol monomethylether, and propylene glycol monoethylether; polyol arylethers such as ethylene glycol monophenylether and ethylene glycol monobenzylether; nitrogen-containing heterocyclic compounds such as 2-pyrrolidone, N-methyl-2-pyrrolidone, N-hydroxyethyl-2-pyrrolidone, 1,3-dimethyl-2-imidazolidinone, ε-caprolactam, and γ-butyrolactone; amides such as formamide, N-methylformamide, N,N-dimethylformamide, 3-methoxy-N,N-dimethyl propionamide, and 3-buthoxy-N,N-dimethyl propionamide; amines such as monoethanolamine, diethanolamine, and triethylamine; sulfur-containing compounds such as dimethyl sulfoxide, sulfolane, and thiodiethanol; propylene carbonate, and ethylene carbonate.

It is preferable to use an organic solvent with a boiling point of at most 250 degrees Celsius, which serves as a humectant that dries quickly.

The proportion of the organic solvent in the ink has no particular limit and can be suitably selected to suit to a particular application.

The proportion in the entire of the ink is preferably from 10 to 60 percent by mass and more preferably from 20 to 60 percent by mass to enhance drying property and discharging reliability of the ink.

### Water

The proportion of water in the ink is not particularly limited and can be suitably selected to suit to a particular application. It is preferably from 10 to 90 percent by mass and more preferably from 20 to 60 percent by mass to quickly dry the ink and stably discharge it.

### Pigment

The pigment includes an inorganic pigment or organic pigment. These can be used alone or in combination. Mixed crystal can also be used as the coloring material.

Examples of the pigments include, but are not limited to, black pigments, yellow pigments, magenta pigments, cyan pigments, white pigments, green pigments, orange pigments, and gloss or metallic pigments of gold, silver, and others.

Carbon black available from known methods such as contact methods, furnace methods, and thermal methods can be used as the inorganic pigment in addition to titanium oxide, iron oxide, calcium carbonate, barium sulfate, aluminum hydroxide, barium yellow, cadmium red, and chrome yellow.

Specific examples of the organic pigments include, but are not limited to, azo pigments, polycyclic pigments (e.g., phthalocyanine pigments, perylene pigments, perinone pigments, anthraquinone pigments, quinacridone pigments, dioxazine pigments, indigo pigments, thioindigo pigments, isoindolinone pigments, and quinophthalone pigments), dye chelates (e.g., basic dye type chelates and acid dye type chelates), nitro pigments, nitroso pigments, and aniline black. Of these pigments, pigments with high affinity with solvents are preferable. Hollow resin particles and hollow inorganic particles can also be used.

Specific examples of the pigments for black include, but are not limited to, carbon black (C.I. Pigment Black 7) such as furnace black, lamp black, acetylene black, and channel black, metals such as copper, iron (C.I. Pigment Black 11), and titanium oxide, and organic pigments such as aniline black (C.I. Pigment Black 1).

Specific examples of the pigments for color include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138,150, 153, 155, 180, 185, and 213; C.I. Pigment Orange 5, 13, 16, 17, 36, 43, and 51, C.I. Pigment Red 1, 2, 3, 5, 17, 22, 23, 31, 38, 48:2 {Permanent Red 2B(Ca)}, 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3, 15:4, (Phthalocyanine Blue), 16, 17:1, 56, 60, and 63, C.I. Pigment Green 1, 4, 7, 8, 10, 17, 18, and 36.

The proportion of the pigment in the ink is preferably from 0.1 to 15 percent by mass and more preferably from 1 to 10 percent by mass to enhance the image density, fixability, and discharging stability.

To obtain the ink, the pigment is dispersed by, for example, preparing a self-dispersible pigment by introducing a hydrophilic functional group into the pigment, coating the surface of the pigment with resin, or using a dispersant.

To introduce a hydrophilic group into a pigment to make a pigment self-dispersible, it is possible to add a functional group such as a sulfone group and a carboxyl group to a pigment (e.g., carbon) to make the pigment dispersible in water.

One method of coating the surface of a pigment with resin and dispersing it is to encapsulate the pigment in microcapsules, allowing it to be dispersed in water. This microencapsulated pigment is also referred to as a resin-coated pigment. The resin-coated pigment particles in ink are not necessarily entirely coated with resin.

Pigment particles not partially or wholly covered with resin may be dispersed in ink unless such particles have an adverse impact.

One such method of using a dispersant for dispersing a pigment is to use a known dispersant of a small or large molecular weight, typically a surfactant.

As the dispersant, an anionic surfactant, a cationic surfactant, a nonionic surfactant, an amphoteric surfactant, or others can be selected depending on a pigment.

Also, a nonionic surfactant, RT-100, available from TAKEMOTO OIL & FAT CO., LTD. and a formalin condensate of naphthalene sodium sulfonate are suitable as the dispersant.

Those can be used alone or in combination.

### Pigment Dispersion

It is also possible to mix a pigment with water, a dispersant, and other substances to prepare a pigment dispersion and thereafter mix the pigment dispersion with materials such as water and an organic solvent to manufacture ink.

The particle size of this pigment dispersion is adjusted by dispersing with water, a pigment, a pigment dispersant, and other optional components. It is good to use a dispersing device for dispersion.

The particle diameter of the pigment in the pigment dispersion has no particular limit. For example, the maximum frequency is preferably from 20 to 500 nm and more preferably from 20 to 150 nm in the maximum number conversion to improve dispersion stability of the pigment and ameliorate discharging stability and the image quality such as image density. The particle diameter of a pigment can be analyzed using a particle size analyzer (Nanotrac Wave-UT151, available from MicrotracBEL Corp).

The proportion of the pigment in the pigment dispersion is not particularly limited and can be suitably selected to suit a particular application. It is preferably from 0.1 to 50 percent by mass and more preferably from 0.1 to 30 percent by mass to achieve good discharging stability and high image density.

It is preferable that the pigment dispersion be filtered with an instrument such as filter and a centrifuge to remove coarse particles followed by deaerating.

### Resin

The type of the resin contained in the ink has no particular limit and can be suitably selected to suit to a particular application. It includes, but are not limited to, urethane resins, polyester resins, acrylic-based resins, vinyl acetate-based resins, styrene-based resins, butadiene-based resins, styrene-butadiene-based resins, vinylchloride-based resins, acrylic styrene-based resins, and acrylic silicone-based resins.

Resin particles made of such resins can be also used. It is possible to obtain an ink by mixing a resin emulsion in which such resin particles are dispersed in water as a dispersion medium with materials such as a pigment and an organic solvent. The resin particle can be synthesized or procured. These resins can be used alone or two or more types of the resin particles.

The volume average particle diameter of the resin particle is not particularly limited and can be suitably selected to suit to a particular application. The volume average particle diameter is preferably from 10 to 1,000 nm, more preferably from 10 to 200 nm, and particularly preferably from 10 to 100 nm to achieve good fixability and image robustness.

The volume average particle diameter can be measured by using a device such as a particle size analyzer (Nanotrac Wave-UT151, available from MicrotracBEL Corp.).

The proportion of the resin is not particularly limited and can be suitably selected to suit to a particular application. It is preferably from 1 to 30 percent by mass and more preferably from 5 to 20 percent by mass to the entire ink to ensure fixability and storage stability of the ink.

The particle diameter of the solid portion in the ink has no particular limit and can be suitably selected to suit to a particular application. For example, the maximum frequency in the maximum number conversion is preferably from 20 to 1,000 nm and more preferably from 20 to 150 nm to enhance the discharging stability and image quality such as optical density. The solid content includes particles such as resin particles and pigment particles. The particle diameter can be measured by using a particle size analyzer (Nanotrac Wave-UT151, available from MicrotracBEL Corp).

### Additive

The ink may further optionally include additives such as a surfactant, defoaming agent, preservative and fungicide, corrosion inhibitor, and pH regulator.

### Surfactant

Examples of the surfactant include, but are not limited to, silicone-based surfactants, fluorochemical surfactants, amphoteric surfactants, nonionic surfactants, and anionic surfactants.

The silicone-based surfactant has no specific limit and can be suitably selected to suit to a particular application.

Of these, the surfactants not decomposable in a high pH environment are preferable. Examples include, but are not limited to, side chain modified polydimethyl siloxane, both terminal-modified polydimethyl siloxane, one-terminal-modified polydimethyl siloxane, and side-chain-both-terminal-modified polydimethyl siloxane. Silicone-based surfactants having a polyoxyethylene group or a polyoxyethylene polyoxypropylene group as a modification group are particularly preferable because such an aqueous surfactant demonstrates good properties. The silicone-based surfactant includes a polyether-modified silicone-based surfactant, one of which is a compound in which a polyalkylene oxide structure is introduced into the side chain of the Si site of dimethyl silooxane.

Specific examples of the fluorochemical surfactant include, but are not limited to, perfluoroalkyl sulfonic acid compounds, perfluoroalkyl carboxylic acid compounds, ester compounds of perfluoroalkyl phosphoric acid, adducts of perfluoroalkyl ethylene oxide, and polyoxyalkylene ether polymer compounds having a perfluoroalkyl ether group in its side chain. These are particularly preferable because the fluorochemical surfactant does not readily produce foams.

Specific examples of the perfluoroalkyl sulfonic acid compounds include, but are not limited to, perfluoroalkyl sulfonic acid and salts of perfluoroalkyl sulfonic acid. Specific examples of the perfluoroalkyl carbonic acid compounds include, but are not limited to, perfluoroalkyl carbonic acid and salts of perfluoroalkyl carbonic acid. Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain, and salts of polyoxyalkylene ether polymers having a perfluoroalkyl ether group in its side chain. Counter ions of salts in these fluorochemical surfactants are, for example, Li, Na, K, NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides.

Specific examples of the anionic surfactants include, but are not limited to, polyoxyethylene alkyl ether acetates, dodecyl benzene sulfonates, laurates, and polyoxyethylene alkyl ether sulfates.

These can be used alone or in combination.

The silicone-based surfactant has no particular limitation and can be suitably selected to suit to a particular application.

Specific examples include, but are not limited to, side-chain-modified polydimethyl siloxane, both end-modified polydimethyl siloxane, one-end-modified polydimethyl siloxane, and side-chain-both-end-modified polydimethyl siloxane. A polyether-modified silicone-based surfactant having a polyoxyethylene group or a polyoxyethylene polyoxypropylene group is particularly preferable because such a surfactant demonstrates good property as an aqueous surfactant.

Such surfactants can be synthesized or commercially procured. Products can be procured from BYK-Chemie GmbH, Shin-Etsu Silicone Co., Ltd., Dow Corning Toray Co., Ltd., NIHON EMULSION Co., Ltd., Kyoeisha Chemical Co., Ltd., and others.

The polyether-modified silicon-based surfactant is not particularly limited and it can be suitably selected to suit to a particular application. One such surfactant is a compound in which the polyalkylene oxide structure represented by the following Chemical Formula S-1 is introduced into the side chain of the Si site of dimethyl polysiloxane.

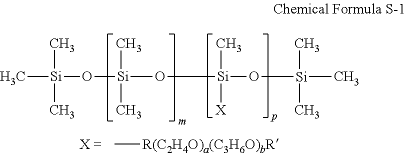

In the Chemical Formula S-1, illustrated above, m, n, a, and b each, independently represent integers. R and R′ each, independently represent alkyl groups and alkylene groups.

The polyether-modified silicone-based surfactants can be procured.

Specific examples include, but are not limited to, KF-618, KF-642, and KF-643 (all available from Shin-Etsu Chemical Co., Ltd.), EMALEX-SS-5602 and SS-1906EX (both available from NIHON EMULSION Co., Ltd.), FZ-2105, FZ-2118, FZ-2154, FZ-2161, FZ-2162, FZ-2163, and FZ-2164 (all available from Dow Corning Toray Co., Ltd.), BYK-33 and BYK-387 (both available from BYK-Chemie GmbH), and TSF4440, TSF4452, and TSF4453 (all available from Momentive Performance Materials Inc.).

A fluorochemical surfactant in which the number of carbon atoms replaced with fluorine atoms is 2 to 16 is preferable and, 4 to 16, more preferable.

Specific examples of the fluorochemical surfactant include, but are not limited to, perfluoroalkyl phosphoric acid ester compounds, adducts of perfluoroalkyl with ethylene oxide, and polyoxyalkylene ether polymer compounds having a perfluoroalkyl ether group in its side chain. Of these, polyoxyalkylene ether polymer compounds having a perfluoroalkyl ether group in its side chain are preferable because these do not readily foam and the fluorochemical surfactant represented by the following Chemical Formula F-1 or Chemical Formula F-2 is preferable.

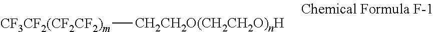

In the Chemical Formula F-1, “m” is preferably 0 or an integer of from 1 to 10 and “n” is preferably 0 or an integer of from 1 to 40.

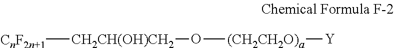

In the compound represented by the Chemical Formula F-2, Y represents H or CₙF₂n+₁, where n represents an integer of from 1 to 6, or CH₂CH(OH)CH₂—CₙF₂ₙ₊₁, where n represents an integer of from 4 to 6, or CₚH₂ₚ₊₁, where p is an integer of from 1 to 19. a represents an integer of from 4 to 14.

The fluorochemical surfactant can be procured. Specific examples include, but are not limited to, SURFLON S-111, S-112, S-113, S-121, S-131, S-132, S-141, and S-145 (all available from ASAHI GLASS CO., LTD.); FLUORAD FC-93, FC-95, FC-98, FC-129, FC-135, FC-170C, FC-430, and FC-431 (all available from Sumitomo 3M Limited); MEGAFACE F-470, F-1405, and F-474 (all available from DIC CORPORATION); ZONYL TBS, FSP, FSA, FSN-100, FSN, FSO-100, FSO, FS-300, and UR (available from E.I. du Pont de Nemours and Company); FT-110, FT-250, FT-251, FT-400S, FT-150, and FT-400SW (all available from NEOS COMPANY LIMITED); POLYFOX PF-136A, PF-156A, PF-151N, PF-154, and PF-159 (available from OMNOVA SOLUTIONS INC.); and UNIDYNE™ DSN-403N (available from DAIKIN INDUSTRIES, Ltd.). Of these, in terms of improvement on print quality, in particular coloring property and permeability, wettability, and uniform dying property on paper, FS-300 of E.I. du Pont de Nemours and Company, FT-110, FT-250, FT-251, FT-400S, FT-150, and FT-400SW of NEOS COMPANY LIMITED, POLYFOX PF-151N of OMNOVA SOLUTIONS INC., and UNIDYNE™ DSN-403N (available from DAIKIN INDUSTRIES, Ltd.) are particularly preferable.

The proportion of the surfactant in ink is not particularly limited and it can be suitably selected to suit a particular application. It is preferably from 0.001 to 5 percent by mass and more preferably from 0.05 percent by mass to 5 percent by mass to achieve good wettability and discharging stability and enhance the image quality.

### Defoaming Agent

The defoaming agent has no particular limit. Examples include, but are not limited to silicon-based defoaming agents, polyether-based defoaming agents, and aliphatic acid ester-based defoaming agents. These can be used alone or in combination. Of these, silicone-based defoaming agents are preferable to enhance the ability of braking foams.

### Preservatives and Fungicides

The preservatives and fungicides (preservative and antifungal agents) are not particularly limited. One specific example is 1,2-benzisothiazoline-3-one.

### Corrosion Inhibitor

The corrosion inhibitor has no particular limit. Specific examples include, but are not limited to, acid sulfites and sodium thiosulfates.

### pH Regulator

The pH regulator is not particularly limited as long as it can control the pH to at least 7. It includes, but is not limited to, amines such as diethanol amine and triethanol amine.

Properties of the ink are not particularly limited and they can be suitably selected to suit to a particular application. The ink preferably has properties, such as viscosity, surface tension, and pH, in the following ranges.

The ink preferably has a viscosity of from 5 to 30 mPa·s and more preferably from 5 to 25 mPa·s at 25 degrees Celsius to enhance the print density and text quality and achieve good dischargeability. Viscosity can be measured with equipment such as a rotatory viscometer, RE-80L, available from TOKI SANGYO CO., LTD. The measuring conditions are as follows:
Standard cone rotor (1° 34′×R24)
Sample liquid amount: 1.2 mL
Rate of rotations: 50 rotations per minute (rpm)
25 degrees Celsius
Measuring time: three minutes.

The surface tension of the ink is preferably at most 35 mN/m and more preferably at most 32 mN/m at 25 degrees Celsius because the ink suitably levels on a recording medium and the ink dries in a short time.

pH of the ink is preferably from 7 to 12 and more preferably from 8 to 11 to prevent corrosion of the metal material in contact with liquid.

### Pre-Treatment Fluid A

The pre-treatment fluid A contains amino-modified silicone, an organic solvent, and water, and may further optionally contain a surfactant, defoaming agent, pH adjuster, preservative/antifungal agent, corrosion inhibitor, and other substances, but contains a negligible amount of organic acids (or free of organic acids). “Negligible” and “or free of” represents none or a tiny amount of a particular component having no impact. For example, a specific component is not detected by a known and familiar technical analysis. Alternatively, it may refer to a case where the organic acid content is at most 0.1 percent by mass in the entire of the pre-treatment fluid A.

The organic solvent, the surfactant, the defoaming agent, the pH regulator, the preservative and antifungal agents, and the corrosion inhibitor are the same materials as those for use in the aqueous pigment ink and materials for use in known pre-treatment fluids.

Using the pre-treatment fluid A can improve the texture of printed matter.

### Amino-Modified Silicone

Amino-modified silicone refers to a substance in which a portion of the methyl groups in dimethyl silicone are substituted with amino group. The pre-treatment with liquid A, which contains amino-modified silicone, can lower the coefficient of friction between fibers, thus improving the texture of the printed product.

There are no particular limitations on the amino-modified silicone used, and it may be selected appropriately according to a particular application.

Specific examples include, but are not limited to, AMC-900 (available from NICCA CHEMICAL CO., LTD.), KF-8004, KF-8015, KF-867S, and KF-8005S (available from Shin-Etsu Chemical Co., Ltd.).

The content of amino-modified silicone is preferably 1 to 15 percent by mass relative to the entire amount of the pre-treatment fluid A, from the standpoint of achieving excellent texture in the printed product.

### Pre-Treatment Fluid B

The pre-treatment fluid B contains an organic acid, a water-soluble amine, an organic solvent, water, and optional materials such as a surfactant, a defoaming agent, a pH regulator, a preservative and antifungal agent, and a corrosion inhibitor.

The organic solvent, the surfactant, the defoaming agent, the pH regulator, the preservative and antifungal agents, and the corrosion inhibitor are the same materials as those for use in the aqueous pigment ink and materials for use in known pre-treatment fluids.

Using the pre-treatment fluid B enhances the color development properties of the printed matter.

### Organic Acid

In the context of the present disclosure, the term “organic acid” refers to an organic compound having a carboxyl group in its chemical structure and functioning as a flocculant.

There is no particular limitation on the type of organic acid that may be employed, and it may be appropriately selected depending on the intended purpose.

Specific examples include, but are not limited to, such organic acids include, but are not limited to, malonic acid, citric acid, tartaric acid, malic acid, formic acid, lactic acid, succinic acid, acetic acid, sorbic acid, butyric acid, and propionic acid. Among these, lactic acid, citric acid, and acetic acid are preferred, with lactic acid and citric acid being particularly preferred.

Among these, lactic acid, citric acid, and acetic acid are preferred, with lactic acid and citric acid being particularly preferable.

The content of the organic acid added is preferably 5 to 20 percent by mass relative to the entire amount of the pre-treatment fluid B, from the viewpoint of imparting flocculation functionality and improving liquid affinity.

In the present disclosure, among the chemical structures of organic acids, hydroxyl groups and carboxyl groups are treated as acid groups.

### Water-Soluble Amine

The water-soluble amine used in the present disclosure refers to a compound represented by the following Chemical Formula 1:

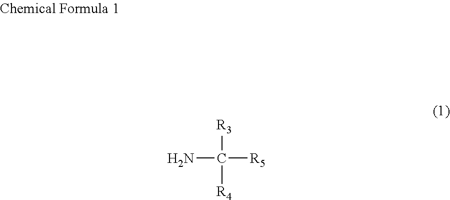

(In the Chemical Formula 1, R₃ represents a hydroxymethyl group; R₄ represents a methyl group, an ethyl group, or a hydroxymethyl group; and R₅ represents a hydrogen atom, a C₁-C₄ alkyl group, or a hydroxymethyl group.)

Preferred examples of the water-soluble amine include, but are not limited to, 2-amino-2-methyl-1,3-propanediol (AMPD), 2-amino-2-ethyl-1,3-propanediol (AEPD), and triethanolamine.

When the total moles of acid group of the organic acid contained in the pre-treatment fluid B is defined as “a”, and the total moles of amino group of the water-soluble amine is defined as “b”, then from the standpoint of liquid affinity, it is preferable that the molar ratio b/a be from 0.08 to 1.00, more preferably 0.08 to 0.30, and particularly preferably 0.12 to 0.30

When a plurality of organic acids and a plurality of water-soluble amines are used, the b/a ratio may be determined in accordance with the following procedure.

For example, when the pre-treatment fluid B contains a first organic acid, a second organic acid, a first water-soluble amine, and a second water-soluble amine, the b/a ratio is calculated by the following formula:

$$b / a = ( {b}_{1} + {b}_{2} ) / ( {a}_{1} + {a}_{2} )$$

In the relationship, a₁ represents the total moles of acid group of the first organic acid, a₂ represents the total moles of acid group of the second organic acid, b₁ represents the total moles of amino group of the first water-soluble amine, and b₂ represents the total moles of amino group of the second water-soluble amine.

By increasing the amount of the pre-treatment fluid A applied, it is possible to further improve the texture of the printed matter. Furthermore, by increasing the amount of the pre-treatment fluid B applied, it is possible to further enhance the color development of the printed matter.

From the standpoint of achieving both favorable texture and color development, the ratio of the amount of the pre-treatment fluid A applied to that of the pre-treatment fluid B (on a volume basis) is preferably from 1.0:0.08 to 1.0:1.2.

### Fluid Applying Method and Fluid Applying Apparatus

The fluid applying method of the present disclosure includes a pre-treatment fluid applying step in which the pre-treatment fluids A and B are applied onto a substrate, and an ink applying step in which the aqueous pigment ink is applied. The method may further optionally include other steps.

The fluid applying apparatus of the present disclosure includes a pre-treatment fluid applying device for applying the pre-treatment fluids A and B onto a substrate, and an ink applying device for applying an aqueous pigment ink. The apparatus may further optionally contain other apparatus.

In the fluid applying method and fluid applying apparatus of the present disclosure, the pre-treatment fluid A used contains an amino-modified silicone, free of an organic acid.

The pre-treatment fluid B used in the fluid applying method and fluid applying apparatus of the present disclosure contains a water-soluble amine and an organic acid.

When the total moles of acid group of the organic acid contained in the pre-treatment fluid B is defined as “a”, and the total moles of amino group of the water-soluble amine is defined as “b”, then the b/a ratio is in the range of 0.08 to 1.00.

In the fluid applying method and fluid applying apparatus of the present disclosure, the ink set of the present disclosure can be suitably used.

It should be noted that, in the present disclosure, the term “fluid applying apparatus” and “fluid applying method” refer to an apparatus capable of discharging the pre-treatment fluid A, the pre-treatment fluid B, the aqueous pigment ink, and various other optional treatment fluids onto a substrate, and a method of applying such fluids using the apparatus. The term “substrate” refers to any material onto which the pre-treatment fluid A, pre-treatment fluid B, aqueous pigment ink, and various other treatment fluids can be temporarily attached, with fabric being particularly preferred.

Moreover, the fluid applying apparatus and method disclosed herein are not limited to forming meaningful visible images, such as characters or diagrams rendered in ink, provided that the application is suitable for printing. Apparatuses and devices for creating patterns like geometric design and 3D images are included.

The method of the present disclosure can be suitably performed using the apparatus of the present disclosure.

The following provides a description of the fluid applying apparatus of the present disclosure in conjunction with an explanation of the fluid applying method.

Pre-treatment Fluid Applying Step and Pre-treatment Fluid Applying Device

In the pre-treatment fluid applying step, the pre-treatment fluids A and B are applied onto a substrate.

The pre-treatment fluid applying device applies the pre-treatment fluids A and B onto a substrate.

The pre-treatment fluid applying step is suitably executed by the pre-treatment fluid applying device.

The method of applying the pre-treatment fluid A and pre-treatment fluid B is not particularly limited and can be appropriately selected according to a particular application. For example, known coating methods can be used, such as:
a method in which the recording medium is immersed in the pre-treatment fluid (dip coating method),
a method in which the pre-treatment fluid is applied using a device such as a roll coater (roller coating method),
a method in which the pre-treatment fluid is sprayed using a device such as a spraying device (spray coating method), and
a method in which the pre-treatment fluid is sprayed using an inkjet system (inkjet coating method). Specific examples of such methods include, but are not limited to, blade coating methods, gravure coating methods, bar coating methods, roll coating methods, curtain coating methods, slide coating methods, and die coating methods.

Among these, the dip coating method, roller coating method, and spraying method are preferred in view of their simple equipment configuration and the ability to quickly apply the pre-treatment fluid. The inkjet method is also preferred because it allows the pre-treatment fluid to be applied only to regions where ink will be applied, and reduces cost.

The amount of the pre-treatment fluid A applied per unit area to a substrate is not particularly limited and can be appropriately selected according to a particular application. However, from the viewpoint of drying properties, it is preferably at most 20 g/m².

The amount of the pre-treatment fluid B applied per unit area to a substrate is also not particularly limited and can be appropriately selected depending on the purpose. However, from the viewpoint that an insufficient amount may impair color development, while an excessive amount may lead to poor image quality due to inadequate dot filling, the amount is preferably between 5 g/m² and 20 g/m², and more preferably between 8 g/m² and 12 g/m².

The applied volume can be adjusted by, for example, increasing the volume of each droplet or altering the droplet density per unit area through a dedicated control mechanism.

In the pre-treatment fluid applying step, the separate application of the pre-treatment fluid A and pre-treatment fluid B allows the application ratio or applied amount between the two to be freely adjusted. By allowing the application ratio between the pre-treatment fluid A and pre-treatment fluid B to be varied, the effects of the pre-treatment fluid A and pre-treatment fluid B can be accordingly controlled, thereby enabling flexible control of the balance between durability and texture. Furthermore, the fluids can still be used for treatment even if the components of pre-treatment fluids A and B are not stably mixed.

### Ink Applying Step and Ink Applying Device

In the ink applying step, the aqueous pigment ink is applied onto a substrate, or the aqueous pigment ink is applied to regions where the pre-treatment fluid A and pre-treatment fluid B have been applied.

The ink applying device applies the aqueous pigment ink onto a substrate, or applies the aqueous pigment ink to regions where the pre-treatment fluid A and pre-treatment fluid B have been applied.

The ink applying step is preferably carried out by the ink applying device.

The method of applying the ink is not particularly limited and can be suitably selected to suit to a particular application. Inkjet discharging is preferable. When ink is discharged by inkjetting, the equipment configuration is simple, ink is applied quickly, and the ink can also be applied selectively to the desired locations, resulting in cost reduction.

The type of ink to be applied is not particularly limited and may be appropriately selected. A single type of ink may be used, or two or more types may be used.

The amount of ink applied per unit area of the substrate is not particularly limited and may be appropriately selected according to a particular application. From the viewpoint of achieving both sufficient color development and drying properties of the ink on a substrate, it is preferably from 5 to 50 g/m², and more preferably from 5 to 30 g/m². An amount of at least 5 g/m² is preferable because it provides color development sufficient for practical use. An amount of at most 50 g/m² is preferable because the amount of volatile components applied does not become excessive, thereby improving drying properties and, for example, preventing the pressing time required for drying the printed matter from becoming too long.

### Heat Drying Step and Heat Drying Device

The fluid applying method of the present disclosure may further include a heat drying step in which at least one of the pre-treatment fluid A, pre-treatment fluid B, and aqueous pigment ink applied onto the substrate is heated and dried.

The fluid applying apparatus of the present disclosure may further include a heat drying device for heat drying at least one of the pre-treatment fluid A, pre-treatment fluid B, and aqueous pigment ink applied onto the substrate.

The heat drying step is preferably carried out by the heat drying device.

There are no particular limitations on the method of heat drying, and an appropriate method may be selected depending on the intended purpose. Examples include, but are not limited to, hot air drying, radiant heating, conductive heating, high-frequency drying, microwave drying, heat pressing, and fixation rollers. These can be used alone or in combination. Either contact or non-contact types may be used. From the perspective of improving fastness and shortening heating time, hot air drying and heat pressing are preferred. In the case of hot air drying or heat pressing, the volatile components in the ink can be efficiently evaporated after the pre-treatment fluid A, pre-treatment fluid B, and aqueous pigment ink have been applied to a substrate, thereby improving the fastness of the printed matter (printed product).

The term “heat drying step” and “heat drying device” is used herein because this step and device encompass both heating and drying without distinction. When the substrate is heated and dried at a temperature exceeding natural drying conditions, it is considered to fall under heat drying. Although the temperature exceeding natural drying conditions may vary depending on factors such as the operating environment of the apparatus, it is, for example, at least 35 degrees Celsius.

As for the drying temperature, it may be set to at least 35 degrees Celsius. A temperature in the range of 100 to 200 degrees Celsius is preferable, and more preferably in the range of 100 to 180 degrees Celsius.

However, since heat shrinkage, yellowing, or color bleeding may occur depending on the type of substrate, the temperature is preferably selected as appropriate.

From the standpoint of promoting the reaction between the pre-treatment fluid and the ink, it is preferable that the fluid applying method of the present disclosure does not include a heat drying step between the pre-treatment fluid applying step and the ink applying step.

### Pressure Applying Step and Pressure Applying Device

The fluid applying method of the present disclosure may further include a pressure applying (pressing) step in which pressure is applied to a region to which either or both of the pre-treatment fluid A pre-treatment fluid B has been applied.

The fluid applying apparatus of the present disclosure may further include a pressing device for applying pressure to a region to which either or both of the pre-treatment fluid A pre-treatment fluid B has been applied.

The pressure applying step is preferably carried out by the pressure applying device.

There is no particular limitation on the pressure applying method, and it may be appropriately selected depending on the intended purpose. Examples include, but are not limited to, conveying rollers and heat rollers. Pressure maybe applied from the side on which the pre-treatment fluid is deposited (also referred to as the treated surface), from the opposite side (also referred to as the untreated surface), or from both the treated and untreated surfaces.

### Storage Device

The fluid applying apparatus of the present disclosure may include a storage device for storing each fluid. The storage device includes, for example, a pre-treatment fluid A container, a pre-treatment fluid B container, or an ink container.

One specific example is an ink cartridge.

Example of Fluid Applying Apparatus and Fluid Applying Method

Next, an example of the fluid applying apparatus and the fluid applying method of the present disclosure will be described with reference to the drawings, taking a printing apparatus and a printing method as an example.

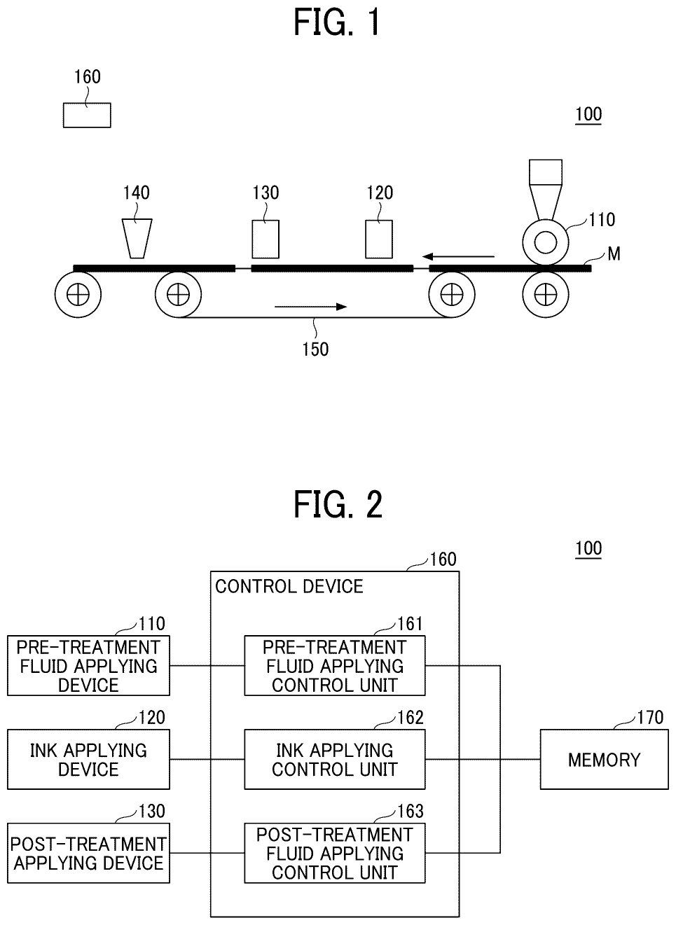

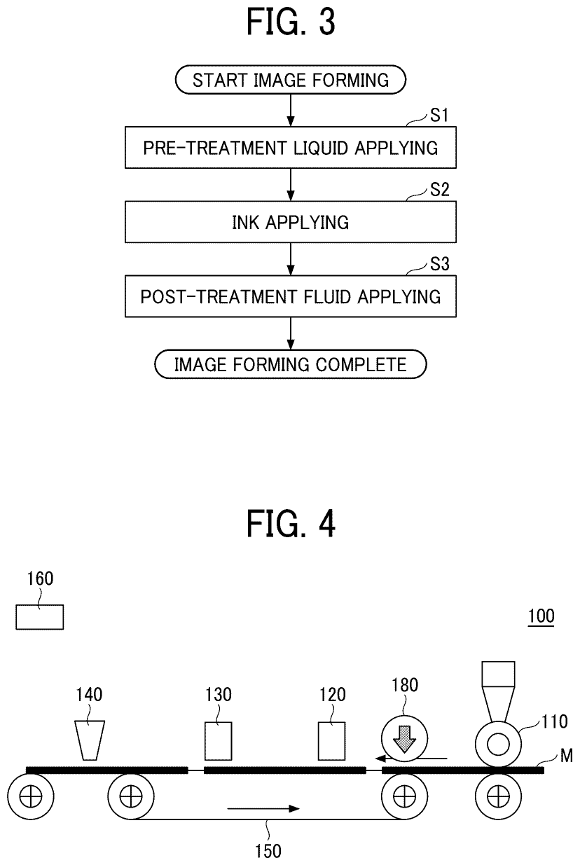

FIG. 1 is a schematic diagram illustrating an example of a printing apparatus according to an embodiment of the present disclosure. FIG. 1 is a schematic diagram illustrating a printing apparatus. FIG. 2 is a flowchart illustrating an example of the operation of the printing apparatus illustrated in FIG. 1. FIG. 3 is a schematic diagram illustrating an example of the control device of the printing apparatus illustrated in FIG. 1.

In the printing method of the present disclosure, the pre-treatment fluid applying step and the ink applying step may be performed using the same printing device or separate, independent equipment (e.g., printing apparatuses).

A printing apparatus 100 includes a pre-treatment fluid applying device 110, an ink applying device 120, and a control device 160. It may furthermore optionally include a post-treatment fluid applying device 130, a heat drying device 140, a conveying device 150, a control device 160, a storage unit (memory) 170, and other members. The control device 160 includes a pre-treatment fluid applying control unit 161, an ink applying control unit 162, and a post-treatment fluid applying control unit 163.

The method of applying the pre-treatment fluid A and the pre-treatment fluid B with the pre-treatment fluid applying device 110 is not particularly limited. Any available method can be used. It includes, but is not limited to, the following methods: dipping a substrate in the pre-treatment fluid A and pre-treatment fluid B (dip coating method); applying the pre-treatment fluid A and pre-treatment fluid B with a roller coater (roller coating method); spraying the pre-treatment fluid A and pre-treatment fluid B with a spraying device (spray coating method); and spraying the pre-treatment fluid A and pre-treatment fluid B by inkjetting (inkjet applying method). Of these, dip coating, roller coating, spray coating, and inkjet coating are preferable to have a simple configuration and quickly apply the pre-treatment fluid A and pre-treatment fluid B.

The ink applying device 120 applies the ink to the surface of the substrate M where the pre-treatment fluid A and pre-treatment fluid B have been applied.

Any known inkjet head can be used as the ink applying device 120.

The storage unit 170 is a hard disk drive (HDD) and retains data of image to be printed. An example of the control device 160 of the printing apparatus 100 is a central processing unit (CPU) and provides instructions to the storage unit 170 and each control unit.

A pre-treatment fluid applying control unit 161 controls the driving of the pre-treatment fluid applying device 110 in response to the instruction from the control device 160.

An ink applying control unit 162 controls the driving of the ink applying device 120 in response to the instruction from the control device 160.

The post-treatment fluid applying device 130 applies a post-pre-treatment fluid to the region of the surface of the substrate M where the inkjet ink has been applied. The post-treatment fluid applying device 130 can be a spray or a roller other than an inkjet head. The post-treatment fluid applying device 130 can be omitted.

The printing apparatus 100 may include the heat drying device 140 that heats and dries the print surface and the reverse surface of the substrate M to which the pre-treatment fluid A, pre-treatment fluid B, and the ink have been applied. Optionally, the substrate M can be heated and dried after other liquids containing the post-treatment fluid are applied and before and after applying each fluid. As the heat drying device (heater), many known heating devices can be used.

Specific examples of the heat drying device 140 include, but are not limited to, devices for heating with heated wind, radiation heating, conduction heating, or microwave drying, a heat press, and a fixing roller. These can be used alone or in combination of two or more thereof. It is preferable to determine the level of heat drying depending on the heat shrinking property of thickness and material of substrate. Of these, a heat press is preferable to enhance fastness of liquid film and quickly heat the substrate M. The heat drying device 140 may be omitted.

The conveying device 150 conveys the substrate M. There is no specific limitation to the conveying device 150 as long as it can convey the substrate M. A conveyance belt or a platen can be used as the conveying device 150. The conveying device 150 can be omitted.

The printing apparatus 100 may furthermore include a fixing unit for heat-fixing an image formed on the substrate M. The fixing unit is not particularly limited. The fixing unit can be a fixing roller or a heat press.

A desktop printer used as the printing apparatus 100 is further equipped with a fluid container containing the pre-treatment fluids A and B, as well as a post-treatment fluid, along with a fluid discharge head that jets these fluids using an inkjet method. Just like standard color inks such as black, cyan, magenta, and yellow, this head also functions as a device for applying the treatment fluids.

On receiving an instruction of starting image forming, the printing apparatus 100 initiates an image forming operation.

In Step S1, the printing apparatus 100 conveys the substrate M by the conveying device 150 and the pre-treatment fluid applying device 110 applies the pre-treatment fluid to the substrate M. At this time, the pre-treatment fluid applying device 110 may apply the pre-treatment fluid A only to the areas where an image is to be formed, or to the entire surface of the substrate.

The pre-treatment fluid applying device 110 applies the pre-treatment fluid A only to the image forming portion in the substrate M after the application region is determined in response to the instruction from the pre-treatment fluid applying control unit 161 or the control device 160.

The pre-treatment fluid applying device 110 applies the pre-treatment fluid A to the entire of the substrate M in response to the instruction from the pre-treatment fluid applying control unit 161 or the control device 160.

In Step Si, the pre-treatment fluid applying device 110 applies the pre-treatment fluid B to the substrate M fed by the conveying device 150, where the pre-treatment fluid A has been applied. At this point, the pre-treatment fluid applying device 110 applies the pre-treatment fluid B only to the portion where the pre-treatment fluid A has been applied or the entire of the substrate M. In the present disclosure, the pre-treatment fluid applying device 110 preferably applies the pre-treatment fluid B to the portion where the pre-treatment fluid A has been applied.

The pre-treatment fluid B is applied only to the image forming portion in the substrate M after the applied region is determined in response to the instruction from the pre-treatment fluid applying control unit 161 or the control device 160.

The pre-treatment fluid applying device 110 applies the pre-treatment fluid B to the entire of the substrate M in response to the instruction from the pre-treatment fluid applying control unit 161 or the control device 160.

In Step S2, the ink applying device 120 discharges the ink to the substrate M fed by the conveying device 150, where the pre-treatment fluid A and the pre-treatment fluid B have been applied. At this point, the ink applying device 120 applies the ink only to the portion where the pre-treatment fluid A and the pre-treatment fluid B have been applied or the entire of the substrate M. In the present disclosure, the ink applying device 120 preferably applies the ink to the portion where the pre-treatment fluid A and the pre-treatment fluid B have been applied.

The ink applying device 120 discharges the ink only to the image forming portion in the substrate M after the applied region is determined in response to the instruction from the ink applying control unit 162 or the control device 160.

The ink applying device 120 discharges the ink to the entire of the substrate M in response to the instruction from the ink applying control unit 162 or the control device 160.

The printing apparatus 100 may optionally include a sensor for recognizing the position and place of the substrate. Due to the sensor that recognizes the position and the place of the substrate M, the pre-treatment fluid applying device 110 and the ink applying device 120 can more efficiently apply the pre-treatment fluid A, the pre-treatment fluid B, and the ink to the substrate M in Step S1 and Step S2.

After Step S2, the conveying device 150 may convey the substrate M where the pre-treatment fluid A, the pre-treatment fluid B, and the ink have been applied to the heat drying device 140, where the substrate M is dried with heat. The heat drying device 140 is not indispensable to the printing method or the printing apparatus in the present disclosure.

If the heat drying process is not performed, the user may manually perform the heat drying using separate heat drying equipment. In the present disclosure, it is preferable to dispense with the heat drying step.

During this heat drying process, the heat drying time and temperature can be constant or adjusted depending on the amount of the pre-treatment fluid A, the pre-treatment fluid B, and the ink applied. It is preferable to adjust the amount of the pre-treatment fluid A, the pre-treatment fluid B, and the ink applied.

The printing apparatus 100 may optionally include a sensor for recognizing the amount of the pre-treatment fluid A, the pre-treatment fluid B, and the ink applied to the substrate M. Due to this sensor, the drying time and temperature are determined and adjusted in accordance with the amount of the pre-treatment fluid A, the pre-treatment fluid B, and the ink applied to the substrate M. The heat drying device 140 can thus dry the substrate M more efficiently.

The sensor may recognize the amount of the pre-treatment fluid A, the pre-treatment fluid B, and the ink applied to the substrate M based on the amount of liquid actually attached to the substrate M. Alternatively, it can recognize the amount discharged from each applying device to the substrate M by measuring.

The printing apparatus 100 completes the image forming operation by heat drying the substrate M. It may optionally include taking out the substrate M from the printing apparatus 100 and conveying the substrate M. The post-treatment step may be provided in Step S3 after Step S2.

Another Example of Fluid Applying Apparatus and Fluid Applying Method Another example of the fluid applying apparatus and method will be described using a printing device and printing method.

FIG. 4 is a schematic diagram for explaining another example of the printing apparatus. The printing apparatus 100 of this example includes a pressurizing unit 180 between the pre-treatment fluid applying device 110 and the ink applying device 120. The pressurizing unit 180 applies pressure to the region where the pre-treatment fluid has been applied after the pre-treatment fluid is applied to the substrate and before the ink is applied.

In this printing method, a pressurizing step is executed to apply pressure to the region where the pre-treatment fluid has been applied after the pre-treatment fluid applying step and before the ink applying step.

Performing the pressurizing process using the pressurizing unit 180 allows for even spreading of the pre-treatment fluid, thereby preventing blotchiness. In addition, if the substrate is a fabric, the pressurizing step using the pressurizing unit 180 can flatten and smooth the fibrous nap on the fabric surface. This allows for uniformity in ink landing positions and penetration, thereby improving the image quality.

Other examples of the printing apparatus and method of the present disclosure will be described below.

The ink set of the present disclosure can be suitably used for various recording devices employing an inkjet recording method, such as printers, facsimile machines, photocopiers, multifunction peripherals (serving as a printer, a facsimile machine, and a photocopier), and solid freeform fabrication devices (3D printers, additive manufacturing devices, etc.).

The printing apparatus may furthermore optionally include a device relating to feeding, conveying, and ejecting a printing medium and other devices referred to as a pre-treatment device and a post-treatment device in addition to the head portion for discharging an ink.

In addition, the apparatus includes both a serial type device with a movable fluid discharge head and a line type device with a fixed fluid discharge head, unless otherwise specified.

Furthermore, in addition to the desktop type, the printing apparatus includes a device capable of printing images on a wide recording medium having, for example, A0 size and a continuous printer capable of using continuous paper rolled in a roll-like form as a substrate.

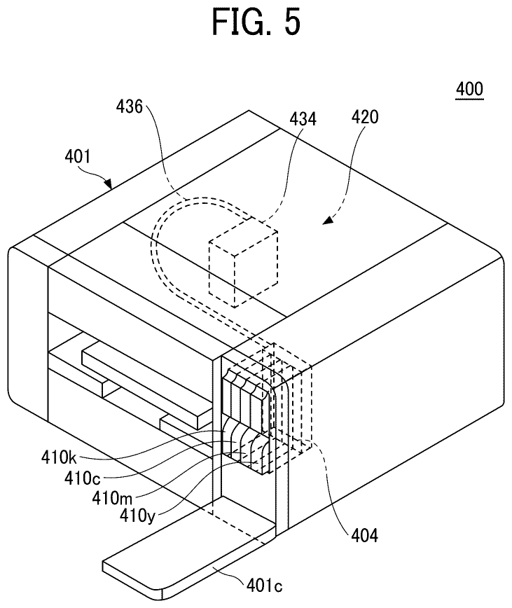

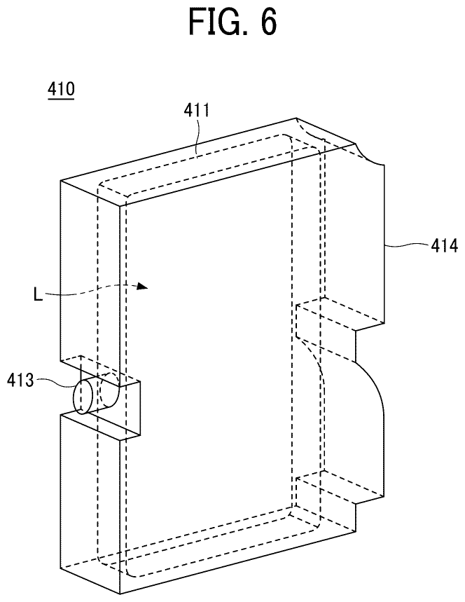

The printing apparatus of this example is described using an example with reference to FIG. 5 and FIG. 6. FIG. 5 is a diagram illustrating a perspective view of the same apparatus. FIG. 6 is a diagram illustrating a perspective view of a tank. A printing device 400 of this example is a serial image forming device. The printing device 400 includes a mechanical unit 420 inside an exterior 401. Each ink accommodating unit (ink container) 411 of each tank 410 (410k, 410c, 410m, and 410y) for each color of black (K), cyan (C), magenta (M), and yellow (Y) is made of a packaging member such as aluminum laminate film. The ink accommodating unit 411 is housed in, for example, a plastic container housing unit 414 and L represents liquid contained in the ink accommodating unit 411. The tank 410 is used as an ink cartridge of each color.

A cartridge holder 404 is disposed on the rear side of the opening appearing when a cover 401c is opened. The tank 410 is detachably attached to the cartridge holder 404. This configuration enables each ink discharging outlet 413 of the tank 410 to communicate with a discharge head 434 for each color via a supplying tube 436 for each color so that the ink can be discharged from the discharge head 434 to a printing medium.

In this example, the printing apparatus may be provided not only with the discharge head 434 for discharging the ink, but also with a pre-treatment fluid discharge head for discharging the pre-treatment fluid and a post-treatment fluid discharge head for discharging the post-treatment fluid.

The printing apparatus of this example may also be provided with a pre-treatment fluid container for storing the pre-treatment fluid, and the pre-treatment fluid is supplied from the pre-treatment fluid container to the pre-treatment fluid discharge head. Further, the printing apparatus of this example may be provided with a post-treatment fluid container for storing the post-treatment fluid, and the post-treatment fluid is supplied from the post-treatment fluid container to the post-treatment fluid discharge head. In this manner, the pre-treatment fluid, ink, and post-treatment fluid can also be applied to a substrate in this example of the printing apparatus.

### Example of Nozzle Surface Cleaning

Next, another example of the printing apparatus and method of the present disclosure will now be described. This example of the printing apparatus includes one or more nozzle surface cleaning devices, and this example of the fluid applying method includes a nozzle surface cleaning step.

In this example, the pre-treatment fluid applying device has a nozzle surface 4 provided with nozzles 5 that discharge the pre-treatment fluid A and nozzles that discharge the pre-treatment fluid B in FIG. 15. The ink applying device has a configuration with a nozzle surface 4 provided with nozzles 5 that discharge the aqueous pigment ink. The ink applying device may have a different configuration other than the fluid applying device. The printing apparatus includes a nozzle surface cleaning device that cleans at least one of the nozzle surfaces of the pre-treatment fluid applying device and the ink applying device and the nozzle surface cleaning device has a wiping member that wipes fluid from the nozzle surfaces.

The printing apparatus with the nozzle surface cleaning device can keep the nozzle surface clean, making it easier to maintain good discharge performance. Inclusion of a nozzle surface cleaning step in the printing method facilitates maintenance of a clean nozzle surface and stable discharge performance.

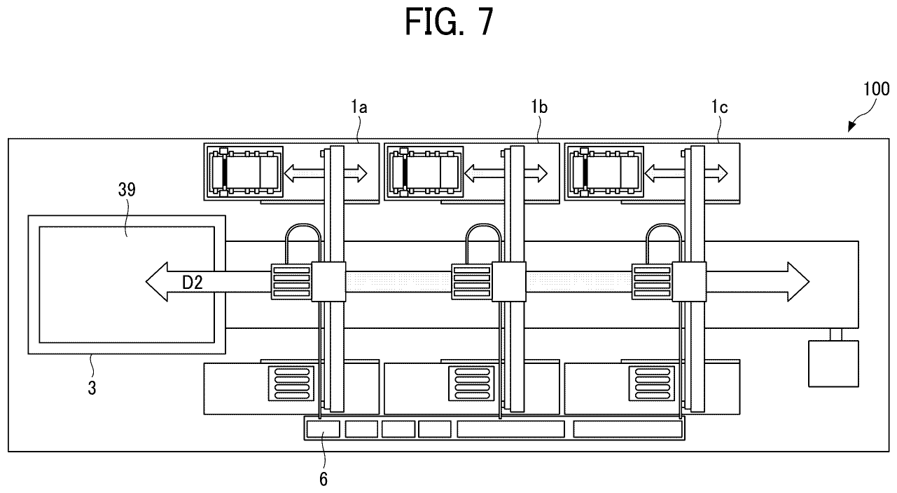

FIG. 7 is a schematic diagram illustrating the printing apparatus of this example. The printing apparatus 100 of this example is an example of a serial-type inkjet printing device. The printing apparatus 100 of this example includes inkjet printing modules 1a, 1b, 1c, and a substrate support member 3.

The inkjet printing modules 1a, 1b, and 1c each have a recording head that discharges fluid. In this example, the inkjet printing module 1a discharges the pre-treatment fluid, the inkjet printing module 1b discharges the ink, and the inkjet printing module 1c discharges the post-treatment fluid. When referring to the inkjet printing modules 1a, 1b, and 1c collectively without distinction, they may be called inkjet printing module 1.

The substrate support member 3 supports a substrate 39 and moves to scan in the direction indicated by an arrow D2. The substrate support member 3 moves to scan beneath the recording heads of the inkjet printing modules 1a, 1b, and 1c. The inkjet printing modules discharge fluid onto the substrate 39 held by the substrate support member 3 to perform printing.

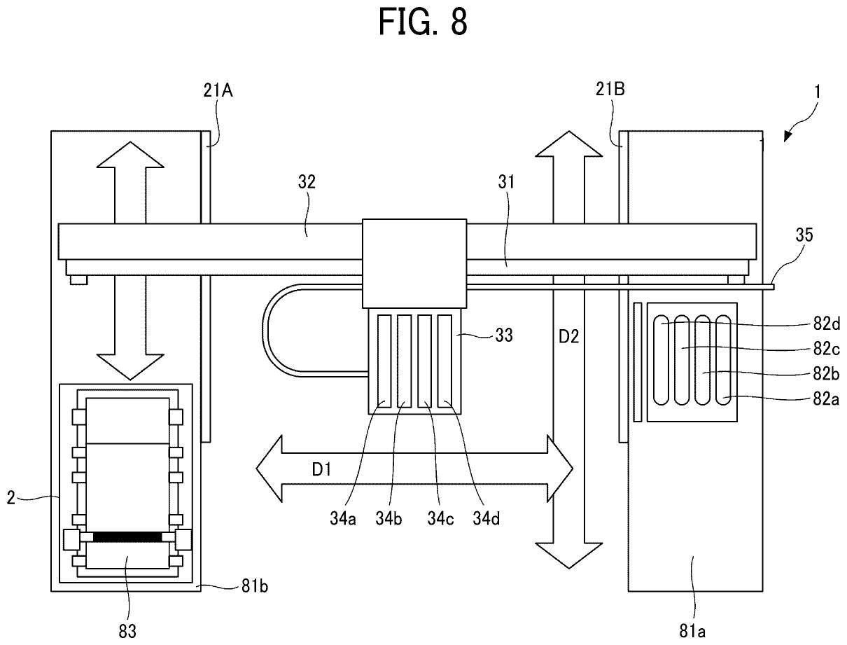

FIG. 8 is a schematic diagram illustrating an example of the inkjet printing module.

The inkjet printing module 1 is a liquid discharge device including a recording head 34 that includes a fluid discharge head that discharges droplets from nozzles, and a maintenance and recovery mechanism 81 for maintaining or recovering the fluid discharge head. The maintenance and recovery mechanism 81 includes a nozzle surface cleaning device 2 that cleans the nozzle surface of the fluid discharge head.

The inkjet printing module 1 has a carriage 33. The carriage 33 is slidably supported in the main scanning direction by a main guide rod 31 and a sub sheet metal guide 32, which are guide members spanning the left and right side plates 21A and 21B of the inkjet printing module 1. The carriage 33 moves and scans in the direction indicated by arrow D1 (the carriage main scanning direction) via a timing belt driven by the main scanning motor.

The carriage 33 has recording heads 34a, 34b, 34c, and 34d (collectively “recording head 34” when not distinguished) including fluid discharge heads that discharge inks of various colors such as yellow (Y), cyan (C), magenta (M), and black (K). The recording head 34 arranges nozzle rows, each having multiple nozzles, in the sub-scanning direction orthogonal to the main scanning direction (direction indicated by an arrow D2). The recording head 34 is mounted on the carriage 33 with the ink droplet discharge direction facing downward.

The carriage 33 is equipped with a supply pump unit and sub-tanks for supplying inks of each color corresponding to the recording heads 34. Inks of each color are replenished and supplied from ink cartridges 6 detachably mounted on a cartridge mounting section into the sub-tanks via supply tubes 35 by the supply pump unit.

When the inkjet printing module 1 has multiple recording heads 34 (34a to 34d), the multiple recording heads 34 may be referred to as a head unit or the like. In the case of an inkjet printing module 1 that discharges the pre-treatment fluid or post-treatment fluid, the recording head 34 it has may be either a single one or multiple. The same treatment fluid may be discharged from the multiple recording heads 34.

As illustrated in FIG. 8, maintenance and recovery mechanisms 81a and 81b are arranged in the non-printing areas on both sides of the scanning direction of the carriage 33 to maintain and recover the condition of the nozzles of the recording head 34. The maintenance and recovery mechanism 81a includes respective cap members (hereinafter referred to as “caps”) 82a, 82b, 82c, and 82d (collectively referred to as “cap 82” when distinction is unnecessary) for capping the nozzle surfaces of the recording head 34. The maintenance and recovery mechanism 81b includes a wiping unit 83 that constitutes the nozzle surface cleaning device 2.

The maintenance and recovery mechanism 81a also includes a dummy droplet receiver for receiving droplets discharged during dummy discharge, which discharges droplets that do not contribute to recording in order to discharge thickened recording fluid, as well as a carriage lock for locking the carriage 33. Furthermore, on the lower side of the maintenance and recovery mechanism 81a, a fixed waste liquid tank that is not replaced is provided to collect waste liquid generated by maintenance and recovery operations, and on the lateral side of the maintenance and recovery mechanism 81a, a replaceable exchangeable waste liquid tank is provided.

As in this example, it is preferable that each inkjet printing module 1 is equipped with its own nozzle surface cleaning device 2. In this case, even if different inks or treatment fluids are used for each inkjet printing module 1, and cleaning operations are performed by the nozzle surface cleaning device 2, the components constituting the inks or treatment fluids do not mix. For example, when using liquids with different polarities such as treatment fluid and ink, if the same nozzle surface cleaning device is used, mixing of fluids may occur within the cleaning device or on the nozzle surface, causing reactions, aggregation, or precipitation of the fluid components, which may lead to discharge failures. On the other hand, according to this example, even when multiple liquids that cannot be mixed, such as the treatment fluid and aqueous pigment ink, or fluids that become unstable after mixing, are used, stable discharge can be maintained.

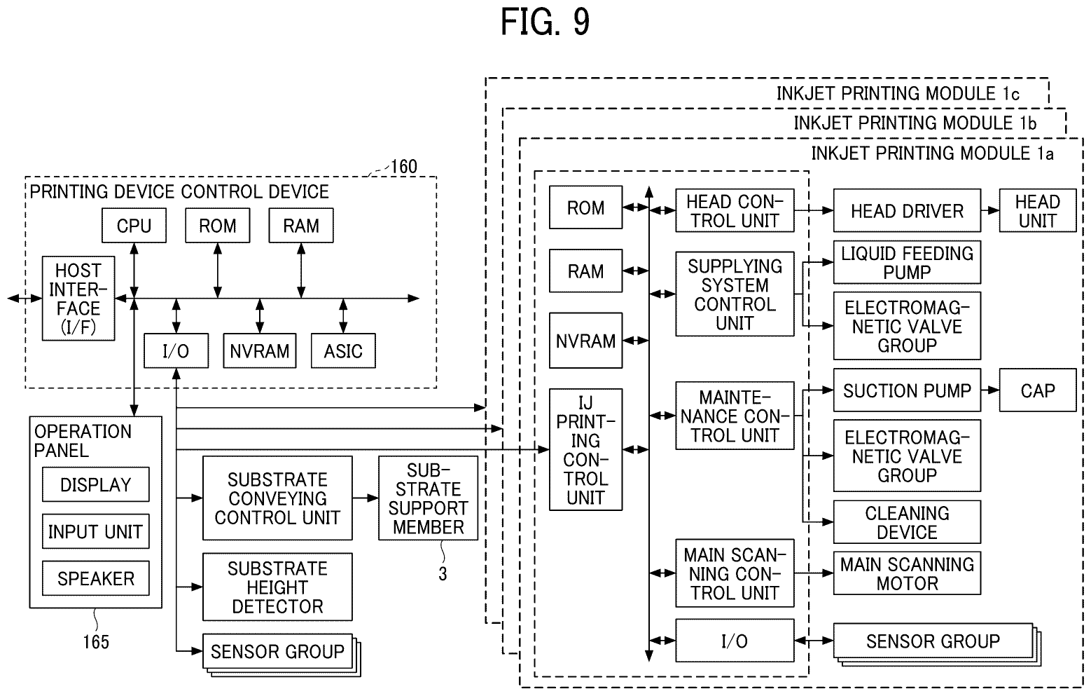

FIG. 9 is an example of a control block diagram of the printing apparatus of this example. The control device 160 controls the substrate support member 3, the inkjet printing module 1, and others, using instructions from an operation panel 165, which includes a display, input panel, and speaker. The substrate support member 3 is controlled, for example, by the substrate conveying control unit. The conveyance of the substrate 39 may also be controlled using a substrate height detector or various sensor groups.

The control device 160 controls the recording head 34 via the inkjet printing control unit (IJ printing control unit), head control unit, and head driver of the inkjet printing module 1. In FIG. 9, a head unit is illustrated as multiple recording heads 34. The control device 160 also controls the fluid supply pump and solenoid valves via the supply system control unit. Additionally, the control device 160 controls the suction pump, cap, electromagnetic valves, and cleaning devices via the maintenance control unit. The cleaning devices include the nozzle surface cleaning device 2 and others. Moreover, the control device 160 controls the main scanning motor via the main scanning control unit. Controlling the main scanning motor allows control over the scanning direction of the carriage 33.

An example of printing in this example will be described.

The substrate support member 3 holds the substrate 39 at the initial position, moves to the recording start position of the inkjet printing module 1a, and stops. The printing apparatus 100 moves the carriage 33 of the inkjet printing module 1a in the main scanning direction D1 while driving the recording head 34 according to the image signal. The inkjet printing module 1a discharges the pre-treatment fluid onto the substrate 39 intermittently conveyed in the D2 direction by the substrate support member 3. Upon receiving a recording complete signal or a signal indicating that the trailing edge of the substrate 39 has reached the printing area, the printing apparatus 100 ends the recording operation of the inkjet printing module 1a and sends the substrate 39 to the inkjet printing module 1b.

The inkjet printing module 1b discharges ink droplets onto the substrate 39 fixed and stopped by the substrate support member 3 to record one line, and after the substrate 39 is conveyed by a predetermined amount, records the next line. Upon receiving a recording complete signal or a signal indicating that the trailing edge of the substrate 39 has reached the recording area, the printing apparatus 100 ends the recording operation of the inkjet printing module 1b and sends the substrate 39 to the inkjet printing module 1c.

The inkjet printing module 1c discharges a post-treatment fluid onto the substrate 39 intermittently conveyed in the D2 direction by the substrate support member 3. Upon the printing apparatus 100 receiving a printing end signal or a signal indicating that the trailing edge of the substrate 39 has reached the recording area, the recording operation of the inkjet printing module 1c ends. When the printing operation ends, the substrate support member 3 returns to the initial position, making the substrate 39 ready for collection.

After the printing operation ends, a maintenance and recovery operation (hereinafter referred to as “maintenance and recovery”) is performed as necessary to maintain or restore the state of the recording head 34 nozzles. The maintenance and recovery operation includes, for example, nozzle suction, dummy discharge, and nozzle surface cleaning. The maintenance and recovery operation involves moving the carriage 33 to the home position facing the maintenance and recovery mechanism 81. Nozzle suction is performed by moving the carriage 33 to the home position, capping with the cap 82, and applying suction to the nozzles. Dummy discharging is performed by moving the carriage 33 to the home position and discharging droplets that do not contribute to image formation. Nozzle surface cleaning is performed by the nozzle surface cleaning device.

Such maintenance and recovery operations ensure image formation by stable droplet discharging.

Next, one example of the nozzle surface cleaning device 2 will be described.

The nozzle surface cleaning device 2 in this embodiment includes a first wiping member, a wiping member conveying device, a wiping member pressing member, a second wiping member, and a holder member.

The first wiping member is a rollable, elongated wiping member that wipes droplets on the nozzle surface.

The wiping member conveying device conveys the first wiping member in the longitudinal direction. The wiping member pressing member presses the first wiping member against the nozzle surface. The second wiping member is a blade-shaped wiping member that wipes droplets on the nozzle surface. The holder member supports the second wiping member either fixedly or pivotably.

Further, the second wiping member contacts the first wiping member by pivoting on the upstream in the conveying direction of the first wiping member relative to the wiping member pressing member. The droplets wiped by the nozzle surface cleaning device 2 are, for example, attached during image formation or unnecessary fluid forcibly discharged from the nozzles by the maintenance and recovery mechanism 81, or attached mist.

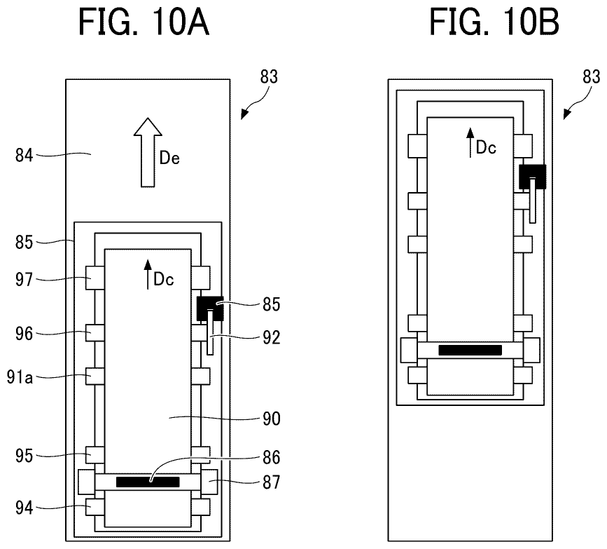

Next, the nozzle surface cleaning device 2 of this embodiment will be described with reference to FIGS. 10 to 13.

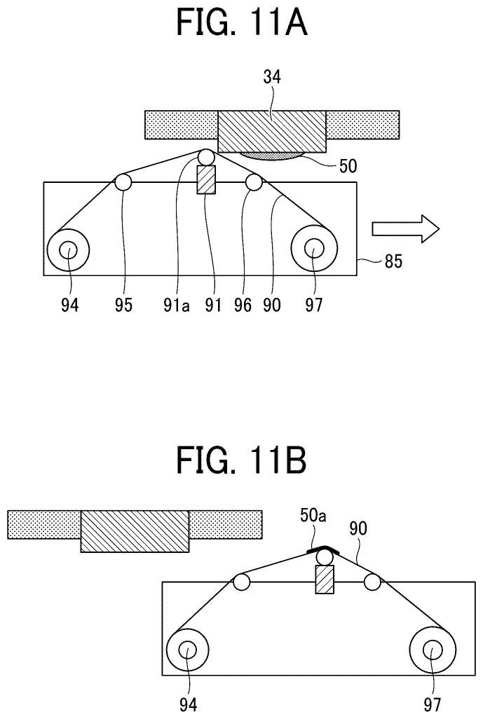

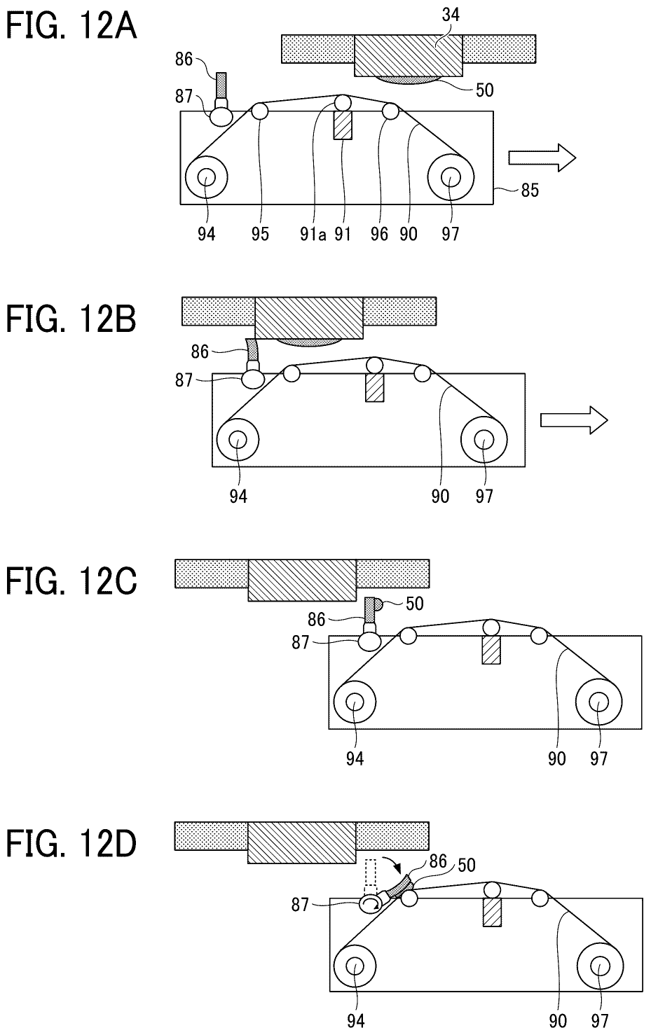

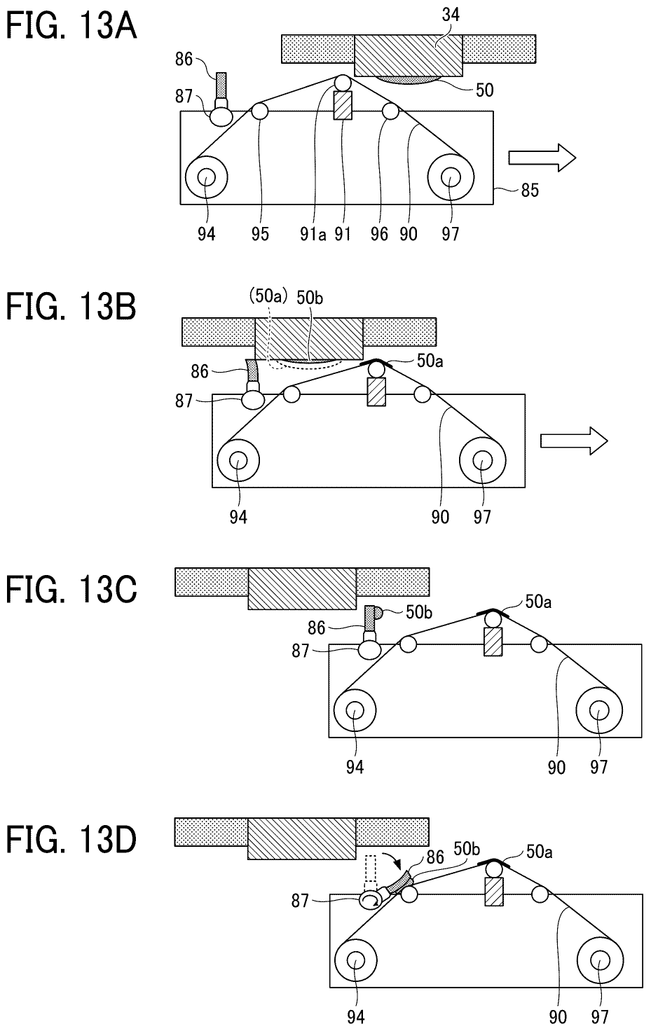

FIGS. 10A and 10B are plan views illustrating an example of the wiping unit 83 constituting the nozzle surface cleaning device 2. FIGS. 10A and 10B differ in the position of the wiping subframe 85. FIG. 11 is a schematic cross-sectional view of an example of the nozzle surface cleaning device 2, illustrating cleaning using a web. FIG. 12 is also a schematic cross-sectional view of another example of the nozzle surface cleaning device 2, illustrating cleaning using a wiper blade. FIG. 13 is a schematic cross-sectional view of another example of the nozzle surface cleaning device 2, illustrating cleaning using both a web and a wiper blade.

The wiping unit 83 includes, for example, a wiping main frame 84 and a wiping subframe 85. The wiping main frame 84 is supported by the fluid discharging device. The wiping subframe 85 is capable of reciprocating movement between the position illustrated in FIG. 10A and the position shown in FIG. 10B. In FIGS. 10A and 10B, an arrow De indicates the wiping direction relative to the recording head 34, and an arrow Dc indicates the conveying direction of a first wiping member 90.

The wiping subframe 85 is equipped with the first wiping member 90, a wiping member conveying device, a wiping member pressing member 91, a second wiping member 86, and a holder member 87.

The first wiping member 90 is a rollable, elongated wiping member that wipes droplets on the nozzle surface. Hereinafter, the first wiping member 90 is sometimes referred to as the web.

The wiping member conveying device conveys the first wiping member 90 in the longitudinal direction. The wiping member conveying device includes a feed roller 94, an upstream roller 95, a roller 91a pressed by a wiping member pressing member 91, a downstream roller 96, and a winding roller 97 from the upstream in the conveying direction of the web 90.

The wiping member pressing member 91 presses the first wiping member 90 against the nozzle surface.

The wiping member pressing member 91 presses the first wiping member 90 against the nozzle surface of the recording head 34 via the roller 91a and preferably has elasticity, such as a compression spring or an elastic material like rubber. The position of the wiping member pressing member 91 in the pressing direction is not fixed; for example, the pressing height can be adjusted by a cam, allowing the web to be switched from non-contact to contact and the pressing pressure during contact to be varied.

The second wiping member 86 is a blade-shaped wiping member that wipes droplets on the nozzle surface. Hereinafter, the second wiping member 86 may be referred to as the wiper blade.

The holder member 87 supports the second wiping member 86 so that it can be fixed or pivoted. Hereinafter, the holder member 87 may be referred to as the wiper holder.

The wiper holder 87 is supported by the wiping subframe 85 and can fix or pivot the wiper blade 86. The wiper blade 86 contacts the web 90 by pivoting on the upstream of the wiping member pressing member 91 in the web's conveying direction.

The mounting position of the wiper holder 87 is not limited to the positions illustrated in FIGS. 12 and 13 as long as it allows the wiper blade 86 to contact the web 90 upstream of the wiping member pressing member 91.

A rotary encoder 92 is mounted coaxially on the downstream roller 96 downstream.

The nozzle surface cleaning device 2 of this example is capable of three types of cleaning operations.

### (1) Web Wiping (for Example, FIG. 11)

In web wiping, the first wiping member (web) 90 wipes droplets on the nozzle surface during one cleaning operation. Web wiping is highly effective to remove ink attached to the nozzle surface, and its cleaning performance can be enhanced by impregnating the web with a cleaning liquid.

The web is, for example, made of fibers and contacts the nozzle at point contact, resulting in high cleaning ability; however, this also causes strong frictional force against the nozzle, which may degrade the water-repellent film on the nozzle surface when wiping is repeated multiple times.

### (2) Blade Wiping (for Example, FIG. 12)

In blade wiping, during one cleaning operation, the second wiping member (wiper blade) 86 wipes droplets on the nozzle surface, and the first wiping member (web) 90 removes droplets adhering to the second wiping member (wiper blade) 86. Blade wiping has a high ability to remove liquid from the nozzle surface and excels at forming a meniscus on the nozzle after cleaning. Since it contacts the nozzle by line contact and surface contact, the frictional force on the nozzle is low, making it less likely to degrade the water-repellent film on the nozzle surface despite repeated wiping.

### (3) Web and Blade Wiping (for Example, FIG. 13)

In web and blade wiping, during one cleaning operation, the first wiping member (web) 90 wipes droplets on the nozzle surface, the second wiping member (wiper blade) 86 wipes droplets on the nozzle surface, and the first wiping member (web) 90 removes droplets adhering to the second wiping member (wiper blade) 86, in this order.

This wiping method has a high ability to remove ink fixated on the nozzle surface and excels at forming a meniscus on the nozzle after cleaning. Also, since the number of web wiping operations can be reduced, it is less likely to degrade the water-repellent film on the nozzle surface.

Additional descriptions will be made regarding FIGS. 11 to 13.

### (1) Web Wiping

FIG. 11A schematically illustrates the state before wiping the nozzle surface with the web 90, and FIG. 11B schematically illustrates the state after wiping the nozzle surface with the web 90. Cleaning of the nozzle surface is performed by relatively moving the wiping subframe 85 with respect to the recording head 34 that has moved to the maintenance and recovery mechanism 81, after a suction operation by the cap 82 connected to a suction pump is performed on the recording head 34. Alternatively, cleaning is performed by relatively moving the wiping subframe 85 with respect to the recording head 34 that has moved to the maintenance and recovery mechanism 81, after the ink is supplied and pressurized from a supply pump to forcibly discharge the ink from the recording head 34. In FIG. 11A, a droplet (ink) 50 targeted for wiping, which remains on the nozzle surface of the recording head 34 before cleaning after the suction operation by the cap 82, is schematically illustrated.

The droplet 50 on the nozzle surface is wiped by moving the wiping subframe 85 in the direction indicated by the arrow in FIG. 11A, pressing the web 90 by the wiping member pressing member 91 against the nozzle surface via the roller 91a, and absorbed into the web 90. The arrow direction in FIG. 11A corresponds to the De direction in FIG. 10.

FIG. 11B schematically illustrates the state in which droplets have been wiped by the web 90 through the operation in FIG. 11A. A droplet 50 remaining on the nozzle surface is removed by the web 90 wiping the nozzle surface. Known configurations can be applied as devices (mechanisms) for driving and conveying the web 90 to perform these operations.

### (2) Blade Wiping

FIGS. 12A and 12B schematically illustrate the state before wiping with the wiper blade 86. FIG. 12C schematically illustrates the state after the nozzle surface has been wiped with the wiper blade 86. FIG. 12D schematically illustrates the state in which the web 90 is cleaning the wiper blade 86 (removing attached droplets).

Cleaning of the nozzle surface is performed by relatively moving the wiping subframe 85 with respect to the recording head 34 that has moved to the maintenance and recovery mechanism 81, after a suction operation by the cap 82 connected to a suction pump is performed on the recording head 34. Alternatively, cleaning is performed by relatively moving the wiping subframe 85 with respect to the recording head 34 that has moved to the maintenance and recovery mechanism 81, after the ink is supplied and pressurized from a supply pump to forcibly discharge the ink from the recording head 34.

FIG. 12A schematically illustrates the droplet (ink) 50 targeted for wiping that remains on the nozzle surface of the recording head 34 before cleaning, after the suction operation by the cap 82. The droplet 50 on the nozzle surface is wiped and removed by moving the wiping subframe 85 in the direction indicated by the arrow in FIG. 12A, causing the wiper blade 86 to come into contact with the nozzle surface. The arrow direction in FIG. 12A corresponds to the De direction in FIG. 10.

As illustrated in FIG. 12C, the droplet 50 removed from the nozzle surface adheres to the wiper blade 86.

FIG. 12D illustrates the cleaning operation of the wiper blade 86. The droplet 50, which has been removed from the nozzle surface and adhered to the wiper blade 86, is absorbed into the web 90 and thereby removed from the wiper blade 86 when the wiper blade 86 comes into contact with the web 90 through rotation of the wiper holder 87.

The operation of the wiper holder 87 is such that, for example, it is fixed during wiping of the nozzle surface, and after wiping, it rotates downstream in the conveying direction until the wiper blade 86 comes into contact with the web 90. Known configurations can be applied as devices (mechanisms) for driving wiper holder 87 to perform these operations.

### (3) Web and Blade Wiping

FIG. 13A schematically illustrates the state before nozzle surface wiping with the web 90. FIG. 13B schematically illustrates the state after nozzle surface wiping with the web 90 and before wiping with the wiper blade 86. FIG. 13C schematically illustrates the state after nozzle surface wiping with the wiper blade 86. FIG. 13D schematically illustrates the state in which the web 90 is cleaning the wiper blade 86 (removing attached droplets).

Cleaning of the nozzle surface is performed by relatively moving the wiping subframe 85 with respect to the recording head 34 that has moved to the maintenance and recovery mechanism 81, after a suction operation by the cap 82 connected to a suction pump is performed on the recording head 34. Alternatively, cleaning is performed by relatively moving the wiping subframe 85 with respect to the recording head 34 that has moved to the maintenance and recovery mechanism 81, after the ink is supplied and pressurized from a supply pump to forcibly discharge the ink from the recording head 34.

FIG. 13A schematically illustrates the droplet (ink) 50 targeted for wiping that remains on the nozzle surface of the recording head 34 before cleaning, after the suction operation by the cap 82. The wiping subframe 85 moves in the direction indicated by the arrow in FIG. 13A, and the web 90, which is pressed against the nozzle surface by the wiping member pressing member 91 via the roller 91a, comes into contact with the nozzle surface. As a result, the droplet 50 on the nozzle surface are wiped off and absorbed into the web 90.

FIG. 13B schematically illustrates a droplet 50a that has been wiped by the web 90 through the operation in FIG. 13A, and a droplet 50b that remains on the nozzle surface without being wiped off. The remaining droplet 50b on the nozzle surface is wiped off and removed by bringing the wiper blade 86 into contact with the nozzle surface.

As illustrated in FIG. 13C, the droplet 50 removed from the nozzle surface adheres to the wiper blade 86.

FIG. 13D illustrates the cleaning operation of the wiper blade 86. The droplet 50b, which has been removed from the nozzle surface and adhered to the wiper blade 86, is absorbed into the web 90 and thereby removed from the wiper blade 86 when the wiper blade 86 comes into contact with the web 90 through rotation of the wiper holder 87. The operation of the wiper holder 87 is such that, for example, it is fixed during wiping of the nozzle surface, and after wiping, it rotates downstream in the conveying direction until the wiper blade 86 comes into contact with the web 90. Known configurations can be applied as devices (mechanisms) for driving wiper holder 87 to perform these operations.

### Device for Manufacturing Electrode

The apparatus (fluid applying device) according to the present disclosure also includes a manufacturing device for electrodes and electrochemical elements. The following provides a description of an electrode manufacturing device.

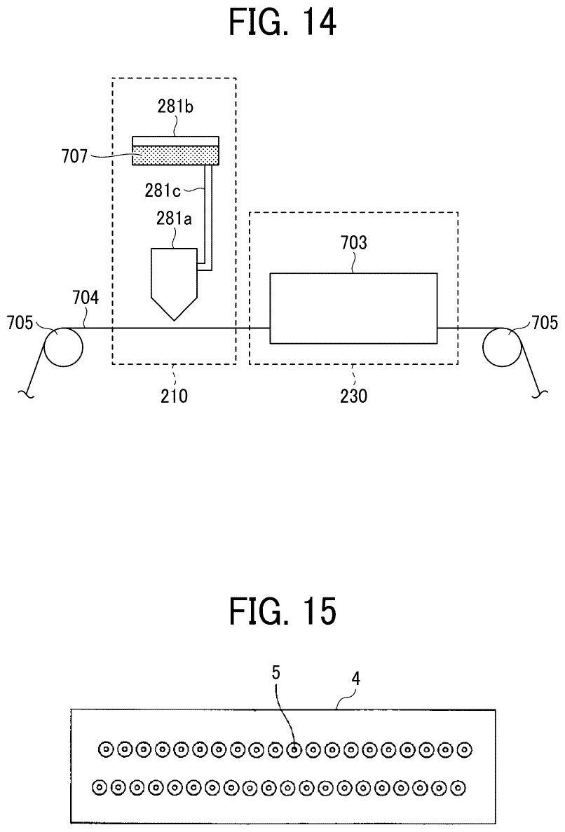

FIG. 14 is a schematic diagram illustrating an example of the electrode manufacturing device according to embodiments of the present disclosure. The electrode manufacturing device manufactures electrodes including a layer containing an electrode material by discharging fluid compositions such as pre-treatment fluid, aqueous pigment ink, and post-treatment fluid using a head module that includes a fluid discharge head.

### Device for Forming Layer Containing Electrode Material, Step for Forming Layer Containing Electrode Material

The discharge device provided in the electrode manufacturing device illustrated in FIG. 14 is a head module according to the embodiment of the present disclosure mentioned above. Discharging the fluid composition from the discharge head of the head module allows it to be applied to a target object, forming a fluid composition layer. There is no particular limitation on the target object (hereinafter also referred to as the “discharge target”) as long as it is a target on which a layer containing an electrode material is to be formed, and it may be appropriately selected according to a particular application. Examples of the target object include, but are not limited to, an electrode substrate (current collector), an active material layer, and a layer containing a solid electrode material. The target object may also be an electrode mixture layer containing an active material formed on an electrode substrate (current collector). The discharge device and discharge step may form a layer containing an electrode material by directly discharging a fluid composition onto the discharge target, provided that they are capable of forming a layer containing an electrode material on the discharge target. Alternatively, the discharge device and discharge process may form a layer containing an electrode material by indirectly discharging a fluid composition.

### Other Optional Configuration and Other Optional Process

There are no particular limitations on other configurations included in the device for producing an electrode mixture layer, and such configurations may be appropriately selected according to a particular application. There are no particular limitations on other steps included in the method of producing an electrode mixture layer, and such steps may be appropriately selected according to a particular application. Examples of configurations and steps that may be included in the device and method of producing an electrode mixture layer include a heating device and a heating step.

### Heating Device and Heating Step

The heating device included in the device for producing an electrode mixture layer heats the fluid composition discharged by the discharge device. The heating steps included in the method of producing an electrode mixture layer heats the fluid composition discharged in the discharge step. H eating the fluid composition results in drying the fluid composition layer.

### Configuration for Forming Layer Containing Electrode Material by Direct Discharge of Fluid Composition

As an example of an electrode manufacturing device, an electrode manufacturing device that forms an electrode mixture layer containing an active material on an electrode substrate (current collector) will be described. As illustrated in FIG. 14, the electrode manufacturing device includes a discharge process device 210, which performs a discharge step that applies a fluid composition onto a print substrate 704 having a discharge target to form a fluid composition layer, and a heating process device 230, which performs a heating step that heats the fluid composition layer to obtain an electrode mixture layer.

The electrode manufacturing device includes a conveying unit 705 that conveys the print substrate 704. The conveying unit 705 conveys the print substrate 704 through the discharge process device 210 and a heating process device 230, in that order, at a predetermined speed. There are no particular limitations on the method of manufacturing the print substrate 704 having a discharge target such as an active material layer, and any known method may be appropriately selected. The discharge process device 210 includes a fluid discharge head 281a that performs an applying step for applying a fluid composition onto the print substrate 704, a storage container 281b that accommodates the fluid composition 707, and a supply tube 281c that supplies the fluid composition 707 stored in the storage container 281b to the fluid discharge head 281a.

In the discharge process device 210, the fluid composition 707 is discharged from the fluid discharge head 281a and applied onto the print substrate 704, thereby forming a thin film of the fluid composition layer. The storage container 281b maybe configured to be integrated with or detachable from the electrode composite layer manufacturing device. Additionally, the storage container 281b may be designed to add materials to a container that is either integrated with or detachable from the electrode composite layer manufacturing device.

The storage container 281b and the supply tube 281c can be arbitrarily selected as long as the fluid composition 707 can be stably stored and supplied.

In the heating process device 230, a solvent removal step is performed to remove the solvent remaining in the fluid composition layer by heating. Specifically, the solvent remaining in the fluid composition layer is heated and dried by the heating device 703 of the heating process device 230, thereby being removed from the fluid composition layer. As a result, the electrode mixture layer is formed. The solvent removal step in the heating process device 230 may also be carried out under reduced pressure.

There is no particular limitation on the heating device 703, and it can be appropriately selected according to a particular application.

For example, the heating device 703 may include a substrate heater, IR heater, or hot air heater.

The heating device 703 may also be a combination of at least two of the substrate heater, IR heater, and hot air heater. Further, the heating temperature and the heating time can be appropriately selected according to the boiling point of the solvent contained in the fluid composition 707 and the thickness of formed film.

The electrode manufacturing device according to an embodiment of the present disclosure makes it possible to discharge the fluid composition precisely onto the targeted area of the discharge object. The electrode composite layer can be suitably used, for example, as part of the configuration of an electrochemical device. There is no particular limitation on the configuration other than the electrode composite layer in the electrochemical device, and known configuration can be appropriately selected. For example, the configuration other than the electrode composite layer include, but is not limited to, a positive electrode, a negative electrode, and a separator.

### EXAMPLES

Next, the present disclosure is described in detail with reference to Examples but is not limited thereto.

### Preparation of Black Pigment Dispersion 1

A total of 11.2 g of styrene, 2.8 g of acrylic acid, 12 g of lauryl methacrylate, 4 g of polyethylene glycol methacrylate, 4 g of styrene macromer, and 0.4 g of mercapto ethanol were mixed in a flask followed by heating to 65 degrees C. Next, a liquid mixture of 100.8 g of styrene, 25.2 g of acrylic acid, 108 g of lauryl methacrylate, 36 g of polyethylene glycol methacrylate, 60 g of hydroxyethyl methacrylate, 36 g of styrene macromer, 3.6 g of mercapto ethanol, 2.4 g of azobismethyl valeronitrile, and 18 g of methylethyl ketone was added dropwise to the flask in two and a half hours. Subsequently, a liquid mixture of 0.8 g of azobismethyl valeronitrile and 18 g of methylethyl ketone was added dropwise to the flask in 0.5 hours. After one-hour aging at 65 degrees Celsius, 0.8 g of azobismethyl valeronitrile was added followed by aging for another hour to allow reaction. After the reaction was complete, 364 g of methylethyl ketone was added to the flask to obtain 800 g of polymer solution A having a solid content of 50 percent. Next, 28 g of the polymer solution A, 42 g of carbon black (Black Pearls 1000, available from Cabot Corporation), 13.6 g of 1 mol/L potassium hydroxide solution, 20 g of methylethyl ketone, and 13.6 g of water were sufficiently stirred followed by mixing and kneading with a roll mill to obtain a paste. The paste obtained was placed in 200 g of pure water followed by sufficient stirring. Methylethyl ketone was removed with an evaporator followed by pressure-filtering with a polyvinylidene fluoride membrane filter having an average pore diameter of 5 m. The moisture of the filtrate was adjusted to obtain Black Pigment Dispersion 1 having a concentration of solid portion of 20 percent.

### Preparation of Pre-treatment Solution A1, Pre-treatment Solution B1, and Aqueous Pigment Ink 1

The materials listed below were mixed and stirred, then filtered through a filter with an average pore size of 5 m (Mini Sartorius, available from Sartorius) to prepare Pre-treatment Solution A-1, Pre-treatment Solution B-1, and Aqueous Pigment Ink 1.

### Pre-treatment Solution A1

Amino-modified silicone AMC-900 (available from NICCA CHEMICAL CO.,LTD.): 10 parts by mass
Propylene glycol: 40 parts
PROXEL XLII: 0.3 parts
Deionized water: balance (100 parts in total)

### Pre-Treatment Solution B1

Toluene (available from Kanto Chemical CO.,INC.): 10 parts
Propylene glycol: 35 parts
2-amino-2-ethyl-1,3-propane diol (available from Tokyo Chemical Industry Co., Ltd.): 3 parts
PROXEL XLII: 0.3 parts
Deionized water: balance (100 parts in total)

### Aqueous Pigment Ink 1

Black pigment dispersion 1 mentioned above: 20 parts
Urethane resin W-6110 (available from Mitsui Chemicals, Inc.): 11 parts
SAG503A, silicone surfactant having an HLB value of 11, available from Nissin Chemical co., ltd.: 0.1 parts
Propylene glycol: 30 parts
PROXEL LV, preservative and antifungal agent, available from AVECIA GROUP: 0.1 parts
2-amino-2-ethyl-1,3-propane diol (available from Tokyo Chemical Industry Co., Ltd.): 0.5 parts
Deionized water: balance (100 parts by mass in total)

### Preparation of Pre-treatment Solutions A2 to A10, Pre-treatment Solutions B2 to B18, and Aqueous Pigment Inks 2 to 4

Pre-treatment solutions A2 to A10, pre-treatment solutions B2 to B18, and aqueous pigment inks 2 to 4 were prepared in the same manner as in Preparation of Pre-treatment Solution A1, Pre-treatment Solution B1, and Aqueous Pigment Ink 1 except that the prescriptions were changed to those as shown in Tables 1 to 4. The details of each component in Tables 1 to 4 are as follows.
Triethylene glycol (available from Mitsubishi Chemical Corporation)
Glycerin (available from Sakamoto Yakuhin Kogyo Co., Ltd.)
KF-8004 (available from Shin-Etsu Chemical Co., Ltd.)
OLFINE® E1010, available from Nissin Chemical Co., Ltd.
BYK348 (available from BYK)
Acetic acid (available from FUJIFILM Wako Pure Chemical Corporation)
Succinic acid (available from FuJIFILM Wako Pure Chemical Corporation)
Lactic acid (available from Tokyo Chemical Industry Co. Ltd.)
Calcium nitrate tetrahydrate (available from FUJIFILM Wako Pure Chemical Corporation)
TAKELAC™ WS-6021, (available from Mitsui Chemicals, Inc.)
HYDRAN™ WLS-213 (available from DIC Corporation)
Mowinyl 7320 (available from The Nippon Synthetic Chemical Industry Co.,Ltd.)
2-pyrrolidone (available from FUJIFILM Wako Pure Chemical Industries, Ltd.)
Triethylene glycol monobutyl ether, available from Tokyo Chemical Industry Co. Ltd.
Diethylene glycol monobutyl ether (available from Tokyo Chemical Industry Co. Ltd.)
Triethanol amine (available from Tokyo Chemical Industry Co. Ltd.)

The storage stability and liquid contact properties of Pre-treatment Solutions A1 to A10 and B1 to B18 were evaluated using the methods described below.

### Storage Stability

Each of Pre-treatment Solution A and Pre-treatment Solution B was placed in a 50 cc plastic container with 40 cc of liquid, sealed with a lid, and stored for two weeks under conditions of 60 degrees Celsius and 60 percent relative humidity. The viscosity before and after storage was measured, and the rate of change in viscosity was evaluated according to the criteria below. The grade B or higher was considered as passing.

### Evaluation Criteria

A: Viscosity change ratio is greater than −5 percent to less than 5 percent
B: Viscosity change ratio is greater than −10 to −5 percent and 5 percent to less than 10 percent
C: Viscosity change ratio exceeds ±10 percent, abnormalities such as gelation are present

### Evaluation on Degradation of Liquid Contact Member

The MH5421 inkjet head (available from Ricoh) was filled with the desired pre-treatment solution in all nozzles and kept in a humidified state using a moisture retention cap, after confirming that no abnormal images were output. It was then stored for one month under conditions of 50 degrees Celsius and 60 percent relative humidity. After storage, printing was performed, and cleaning was carried out until the inkjet head returned to a condition equivalent to the initial state, with no missing or jetting irregularities observed. The degradation of liquid contacting members was then evaluated. The grade B or higher was considered as passing.

### Evaluation Criteria

A: Restores to a condition equivalent to the initial state through cleaning
B: Does not fully return to the initial condition even after repeated cleaning, but the number of defective nozzles is less than 1 percent of the total
C: Does not return to the initial condition despite repeated cleaning, and the number of defective nozzles is at least 1 percent of the total

TABLE 1

| | | Pre- | Pre- | Pre- | Pre- | Pre- |
|---|---|---|---|---|---|---|
| | | treatment | treatment | treatment | treatment | treatment |
| | | Solution | Solution | Solution | Solution | Solution |
| | | A1 | A2 | A3 | A4 | A5 |
| Organic solvent | PG | 40 | 60 | 40 | 60 | 40 |
| | Triethylene | | | | | |
| | glycol | | | | | |
| | Glycerin | | | | | |
| Flocculant | Citric acid | | | | | 10 |
| Amino-modified | AMC-900 | 10 | 1 | | | 10 |
| silicone | KF-8004 | | | 10 | | |
| Water-soluble | AEPD | | | | | |
| amine | | | | | | |
| Surfactant | OLFINE ® | | | | | |
| | E1010 | | | | | |
| | BYK348 | | | | | |
| Antibacterial | Proxel XLII | 0.3 | 0.3 | 0.3 | 0.3 | 0.3 |
| agent | | | | | | |
| Water | | Balance | Balance | Balance | Balance | Balance |
| Total | | 100 | 100 | 100 | 100 | 100 |
| Evaluation | Storage | A | A | A | A | A |
| | stability | | | | | |
| | Degradation | A | A | A | A | C |
| | of Liquid | | | | | |
| | Contact | | | | | |
| | Member | | | | | |
| | | Pre- | Pre- | Pre- | Pre- | Pre- |
| | | treatment | treatment | treatment | treatment | treatment |
| | | Solution | Solution | Solution | Solution | Solution |
| | | A6 | A7 | A8 | A9 | A10 |
| Organic solvent | PG | 35 | 25 | 25 | 25 | 10 |
| | Triethylene | | 10 | 10 | 10 | |
| | glycol | | | | | |
| | Glycerin | | 5 | 5 | 5 | |
| Flocculant | Citric acid | 10 | | | | |
| Amino-modified | AMC-900 | 10 | 10 | 10 | 10 | 15 |
| silicone | KF-8004 | | | | | |
| Water-soluble | AEPD | 3 | | | | |
| amine | | | | | | |
| Surfactant | OLFINE ® | | | 1.2 | | |
| | E1010 | | | | | |
| | BYK348 | | | | 0.15 | |
| Antibacterial | Proxel XLII | 0.3 | 0.3 | 0.3 | 0.3 | 0.3 |
| agent | | | | | | |
| Water | | Balance | Balance | Balance | Balance | Balance |
| Total | | 100 | 100 | 100 | 100 | 100 |
| Evaluation | Storage | C | A | A | A | A |
| | stability | | | | | |
| | Degradation | A | A | A | A | A |
| | of Liquid | | | | | |
| | Contact | | | | | |
| | Member | | | | | |

TABLE 2

| | | Pre- | Pre- | Pre- | Pre- | Pre- |
|---|---|---|---|---|---|---|
| | | treatment | treatment | treatment | treatment | treatment |
| | | Solution | Solution | Solution | Solution | Solution |
| | | B1 | B2 | B3 | B4 | B5 |
| Organic | PG | 35 | 35 | 35 | 35 | 35 |
| solvent | Triethylene | | | | | |
| | glycol | | | | | |
| | Glycerin | | | | | |
| Flocculant | Citric acid | 10 | 10 | 10 | 10 | 10 |
| | Acetic acid | | | | | |
| | Succinic acid | | | | | |
| | Lactic acid | | | | 10 | |
| | Calcium | | | | | |
| | nitrate | | | | | |
| Amino- | AMC-900 | | | | | |
| modified | | | | | | |
| silicone | | | | | | |
| Water-soluble | AEPD | 3 | 25 | 7.5 | 8 | |
| amine | AMPD | | | | | |
| | Triethanol | | | | | |
| | amine | | | | | |
| Surfactant | OLFINE ® | | | | | |
| | E1010 | | | | | |
| | BYK 348 | | | | | |
| Antibacterial | Proxel XLII | 0.3 | 0.3 | 0.3 | 0.3 | 0.3 |
| agent | | | | | | |
| Water | | Balance | Balance | Balance | Balance | Balance |
| Total | | 100 | 100 | 100 | 100 | 100 |
| b/a | | 0.12 | 1.00 | 0.30 | 0.30 | 0.00 |
| Evaluation | Storage | A | B | A | A | A |
| | stability | | | | | |
| | Degradation | A | A | A | A | C |
| | of Liquid | | | | | |
| | Contact | | | | | |
| | Member | | | | | |

| | | Pre- | Pre- | Pre- | Pre- |
|---|---|---|---|---|---|
| | | treatment | treatment | treatment | treatment |
| | | Solution | Solution | Solution | Solution |
| | | B6 | B7 | B8 | B9 |
| Organic | PG | 35 | 35 | 35 | 35 |
| solvent | Triethylene | | | | |
| | glycol | | | | |
| | Glycerin | | | | |
| Flocculant | Citric acid | | 10 | 10 | 10 |
| | Acetic acid | | | | |
| | Succinic acid | | | | |
| | Lactic acid | | | | |
| | Calcium | 10 | | 10 | |
| | nitrate | | | | |
| Amino- | AMC-900 | | 10 | 10 | |
| modified | | | | | |
| silicone | | | | | |
| Water-soluble | AEPD | | 3 | | 1.3 |
| amine | AMPD | | | | |
| | Triethanol | | | | |
| | amine | | | | |
| Surfactant | OLFINE ® | | | | |
| | E1010 | | | | |
| | BYK 348 | | | | |
| Antibacterial | Proxel XLII | 0.3 | 0.3 | 0.3 | 0.3 |
| agent | | | | | |
| Water | | Balance | Balance | Balance | Balance |
| Total | | 100 | 100 | 100 | 100 |
| b/a | | 0.00 | 0.12 | 0.00 | 0.05 |
| Evaluation | Storage | A | C | C | A |
| | stability | | | | |
| | Degradation | A | — | — | C |
| | of Liquid | | | | |
| | Contact | | | | |
| | Member | | | | |

TABLE 3

| | | Pre- | Pre- | Pre- | Pre- | Pre- |
|---|---|---|---|---|---|---|
| | | treatment | treatment | treatment | treatment | treatment |
| | | Solution | Solution | Solution | Solution | Solution |
| | | B10 | B11 | B12 | B13 | B14 |
| Organic | PG | 20 | 20 | 20 | 20 | 20 |
| solvent | Triethylene | 10 | 10 | 10 | 10 | 10 |
| | glycol | | | | | |
| | Glycerin | 5 | 5 | 5 | 5 | 5 |
| Flocculant | Citric acid | 10 | | | | |
| | Acetic acid | | 10 | | 10 | 10 |
| | Succinic | | | 10 | | |
| | acid | | | | | |
| | Lactic acid | | | | | |
| | Calcium | | | | | |
| | nitrate | | | | | |
| Amino- | AMC-900 | | | | | |
| modified | | | | | | |
| silicone | | | | | | |
| Water-soluble | AEPD | 3 | 2.4 | 2.4 | 2.4 | 2.4 |
| amine | AMPD | | | | | |
| | Triethanol | | | | | |
| | amine | | | | | |
| Surfactant | OLFINE ® | | | | 1.2 | |
| | E1010 | | | | | |
| | BYK348 | | | | | 0.15 |
| Antibacterial | Proxel XLII | 0.3 | 0.3 | 0.3 | 0.3 | 0.3 |
| agent | | | | | | |
| Water | | Balance | Balance | Balance | Balance | Balance |
| Total | | 100 | 100 | 100 | 100 | 100 |
| b/a | | 0.12 | 0.12 | 0.12 | 0.12 | 0.12 |
| Evaluation | Storage | A | A | A | A | A |
| | stability | | | | | |
| | Degradation | A | A | A | A | A |
| | of Liquid | | | | | |
| | Contact | | | | | |
| | Member | | | | | |

| | | Pre- | Pre- | Pre- | Pre- |
|---|---|---|---|---|---|
| | | treatment | treatment | treatment | treatment |
| | | Solution | Solution | Solution | Solution |
| | | B15 | B16 | B17 | B18 |
| Organic | PG | 35 | 35 | 35 | 35 |
| solvent | Triethylene | | | | |
| | glycol | | | | |
| | Glycerin | | | | |
| Flocculant | Citric acid | 10 | 5 | 10 | 10 |
| | Acetic acid | | | | |
| | Succinic | | | | |
| | acid | | | | |
| | Lactic acid | | | | |
| | Calcium | | | | |
| | nitrate | | | | |
| Amino- | AMC-900 | | | | |
| modified | | | | | |
| silicone | | | | | |
| Water-soluble | AEPD | 2 | 1.5 | | |
| amine | AMPD | | | 2.6 | |
| | Triethanol | | | | 3.7 |
| | amine | | | | |
| Surfactant | OLFINE ® | | | | |
| | E1010 | | | | |
| | BYK348 | | | | |
| Antibacterial | Proxel XLII | 0.3 | 0.3 | 0.3 | 0.3 |
| agent | | | | | |
| Water | | Balance | Balance | Balance | Balance |
| Total | | 100 | 100 | 100 | 100 |
| b/a | | 0.08 | 0.12 | 0.12 | 0.12 |
| Evaluation | Storage | A | A | A | A |
| | stability | | | | |
| | Degradation | B | A | A | A |
| | of Liquid | | | | |
| | Contact | | | | |
| | Member | | | | |

TABLE 4

| | | Ink 1 | Ink 2 | Ink 3 | Ink 4 |
|---|---|---|---|---|---|
| Pigment | Black pigment | 20 | 15 | 18 | 18 |
| dispersion | dispersion 1 | | | | |
| Resin | WS-6021 | | 7 | | |
| | HYDRAN ™ | | | | 5 |
| | WLS-213 | | | | |
| | Mowinyl 7320 | | | 8 | |
| | W-6110 | 11 | | | |
| Organic | 2-pyrroridone | | 2 | | 3 |
| solvent | Glycerin | | 20 | 7 | 15 |
| | Triethylene glycol | | 1 | 3 | 5 |
| | Triethylene glycol | | 1 | 1 | |
| | monobutyl ether | | | | |
| | Diethylene glycol | | | | |
| | monobutyl ether | | | | |
| | Propylene glycol | 30 | | | |
| Surfactant | BYK-348 | | 0.3 | 0.3 | |
| | OLFINE ® E1010 | | | | 1 |
| | SAG503A | 0.1 | | | |
| Antibacterial | Proxel XLII | | | | 0.1 |
| agent | PROXEL LV | 0.1 | | | |
| pH regulator | Triethanol amine | | 0.5 | 0.5 | 0.5 |
| | AEPD | 0.5 | | | |

| | | | | |
|---|---|---|---|---|
| Water | Balance | Balance | Balance | Balance |
| Total | 100 | 100 | 100 | 100 |

### Example 1

For the production of printed matter, an Ri 100 DTG printer (available from Ricoh Co., Ltd.) was used.

Pre-treatment Solution A1, Pre-treatment Solution B1, and Aqueous Pigment Ink 1 were filled into the ink tanks mounted on the inkjet printer above. Pre-treatment Solution A1 was first printed at an applied amount of 10 g/m², followed immediately by Pre-treatment Solution B1 at 10 g/m², and then Aqueous Pigment Ink 1 was printed at 20 g/m². Printing was performed on cotton broadcloth (available from Shikisome Co., Ltd.) and polyester tropical fabric (available from Teijin Ltd.). After printing, the cotton fabric was dried at 160 degrees Celsius for 5 minutes, and the polyester fabric at 130 degrees Celsius for 5 minutes, using a thermostatic oven to complete the production of printed matter.

### Examples 2 to 24 and Comparative Examples 1 to 8

Printed matter was produced in the same manner as in Example 1 except that the types of Pre-treatment Solution A, Pre-treatment Solution B, and Aqueous Pigment Ink were changed to those shown in Tables 5 to 8, as well as the applied amounts of Pre-treatment Solutions A and B.

In Examples 1 to 24 and Comparative Examples 1 to 8, color development, texture, and fastness were evaluated.

The results, including the storage stability of the pre-treatment solutions and the degradation of liquid contacting members, are shown in Tables 5 to 8. In Comparative Examples 6 and 7, Pre-treatment Solutions B-7 and B-8 gelled as standalone liquids, making printing impossible; therefore, evaluation results other than storage stability are indicated as ‘-’.

### Color Development

The printed matter produced using the aforementioned inkjet printer was measured for color density using a spectrophotometer (X-Rite, available from X-Rite Inc.), and their color development was evaluated. The evaluation criteria are as follows: The grade B and above are considered as passing.

### Evaluation Criteria

A: Black density was at least 1.4
B: Black density was 1.25 to less than 1.4
C: Black density was less than 1.25

### Texture

The printed matter produced using the aforementioned inkjet printer were cut into 85 mm squares, and their stiffness was measured using a handrometer (product name: HOM-200, available from DAILI KAGAKU SEIKIMFG. co., ltd.). The grade B orhigher was considered as passing.

### Evaluation Criteria

S: Stiffness is less than 25 g
A: Stiffness is 25 g to less than 35 g
B: Stiffness is 35 g to less than 50 g
C: Stiffness is at least 50 g

### Fastness

Using the printed matterproduced with the aforementioned inkjet printer, a wet rubbing fastness test was conducted in accordance with JIS L 0849 (Test methods for colour fastness to rubbing). A rating of B or higher was considered as passing.

### Evaluation Criteria

A: Wetrubbing fastness level was at least fourth grade
B: Wet rubbing fastness level was from third grade to less than fourth grade
C: Wetrubbing fastness level was less than thirdgrade

TABLE 5

| | | | Example 1 | Example 2 | Example 3 | Example 4 |
|---|---|---|---|---|---|---|
| Pre-treatment fluid A | | | A-1 | A-2 | A-3 | A-1 |
| Pre-treatment fluid B | | | B-1 | B-1 | B-1 | B-2 |
| Ink | | | 1 | 1 | 1 | 1 |
| b/a | | | 0.12 | 0.12 | 0.12 | 1.00 |
| Attached amount of pre-treatment fluid A | | | 10 g/m² | 10 g/m² | 10 g/m² | 10 g/m² |
| Attached amount of pre-treatment fluid B | | | 10 g/m² | 10 g/m² | 10 g/m² | 10 g/m² |
| Evaluation | Coloring | | A | A | A | A |
| | Texture | | A | B | A | A |
| | Fastness | | A | A | A | A |
| | Storage | Pre- | A | A | A | B |
| | stability | treatment | | | | |
| | | fluid A | | | | |
| | | Pre- | A | A | A | B |
| | | treatment | | | | |
| | | fluid B | | | | |
| | Degradation | Pre- | A | A | A | A |
| | of Liquid | treatment | | | | |
| | Contact | fluid A | | | | |
| | Member | Pre- | | | | |
| | | treatment | A | A | A | A |
| | | fluid B | | | | |

| | | | Example 5 | Example 6 | Example 7 | Example 8 |
|---|---|---|---|---|---|---|
| Pre-treatment fluid A | | | A-1 | A-1 | A-7 | A-8 |
| Pre-treatment fluid B | | | B-3 | B-4 | B-1 | B-1 |
| Ink | | | 1 | 1 | 1 | 1 |
| b/a | | | 0.30 | 0.30 | 0.12 | 0.12 |
| Attached amount of pre-treatment fluid A | | | 10 g/m² | 10 g/m² | 10 g/m² | 10 g/m² |
| Attached amount of pre-treatment fluid B | | | 10 g/m² | 10 g/m² | 10 g/m² | 10 g/m² |
| Evaluation | A | | A | A | A | A |
| | A | | A | A | A | A |
| | A | | A | A | A | A |
| | A | A | A | A | A | B |
| | A | A | A | A | A | B |
| | A | A | A | A | A | A |
| | A | A | A | A | A | A |

TABLE 6

| | | | Example 9 | Example 10 | Example 11 | Example 12 |
|---|---|---|---|---|---|---|
| Pre-treatment fluid A | | | A-9 | A-1 | A-1 | A-1 |
| Pre-treatment fluid B | | | B-1 | B-10 | B-11 | B-12 |
| Ink | | | 1 | 1 | 1 | 1 |
| b/a | | | 0.12 | 0.12 | 0.12 | 0.12 |
| Attached amount of pre-treatment fluid A | | | 10 g/m² | 10 g/m² | 10 g/m² | 10 g/m² |
| Attached amount of pre-treatment fluid B | | | 10 g/m² | 10 g/m² | 10 g/m² | 10 g/m² |
| Evaluation | Coloring | | A | A | A | A |
| | Texture | | A | A | A | A |
| | Fastness | | A | A | A | A |
| | Storage | Pre- | A | A | A | A |
| | stability | treatment | | | | |
| | | fluid A | | | | |
| | | Pre- | A | A | A | A |
| | | treatment | | | | |
| | | fluid B | | | | |
| | Degradation | Pre- | A | A | A | A |
| | of Liquid | treatment | | | | |
| | Contact | fluid A | | | | |
| | Member | Pre- | A | A | A | A |
| | | treatment | | | | |
| | | fluid B | | | | |

| | | | Example 13 | Example 14 | Example 15 | Example 16 |
|---|---|---|---|---|---|---|
| Pre-treatment fluid A | | | A-1 | A-1 | A-1 | A-1 |
| Pre-treatment fluid B | | | B-13 | B-14 | B-1 | B-1 |
| Ink | | | 1 | 1 | 2 | 3 |
| b/a | | | 0.12 | 0.12 | 0.12 | 0.12 |
| Attached amount of pre-treatment fluid A | | | 10 g/m² | 10 g/m² | 10 g/m² | 10 g/m² |
| Attached amount of pre-treatment fluid B | | | 10 g/m² | 10 g/m² | 10 g/m² | 10 g/m² |
| Evaluation | Coloring | | A | A | A | A |
| | Texture | | A | A | A | A |
| | Fastness | | A | A | A | A |
| | Storage | Pre- | A | A | A | A |
| | stability | treatment | | | | |
| | | fluid A | | | | |
| | | Pre- | A | A | A | A |
| | | treatment | | | | |
| | | fluid B | | | | |
| | Degradation | Pre- | A | A | A | A |
| | of Liquid | treatment | | | | |
| | Contact | fluid A | | | | |
| | Member | Pre- | A | A | A | A |
| | | treatment | | | | |
| | | fluid B | | | | |

TABLE 7

| | | | Example 17 | Example 18 | Example 19 | | Example 20 |
|---|---|---|---|---|---|---|---|
| Pre-treatment fluid A | | | A-1 | A-1 | A-1 | | A-1 |
| Pre-treatment fluid B | | | B-1 | B-1 | B-1 | | B-15 |
| Ink | | | 4 | 1 | 1 | | 1 |
| b/a | | | 0.12 | 0.12 | 0.12 | | 0.08 |
| Attached amount of pre-treatment fluid A | | | 10 g/m² | 25 g/m² | 10 | g/m² | 10 g/m² |
| Attached amount of pre-treatment fluid B | | | 10 g/m² | 10 g/m² | 5 | g/m² | 10 g/m² |
| Evaluation | Coloring | | A | A | B | | A |
| | Texture | | A | S | A | | A |
| | Fastness | | A | A | A | | A |
| | Storage | Pre- | A | A | A | | A |
| | stability | treatment | | | | | |
| | | fluid A | | | | | |
| | | Pre- | A | A | A | | A |
| | | treatment | | | | | |
| | | fluid B | | | | | |
| | Degradation | Pre- | A | A | A | | A |
| | of Liquid | treatment | | | | | |
| | Contact | fluid A | | | | | |

| | | | | | |
|---|---|---|---|---|---|
| Member | Pre- | A | A | A | A |

treatment
fluid B

| | | | Example 21 | Example 22 | Example 23 | Example 24 |
|---|---|---|---|---|---|---|
| Pre-treatment fluid A | | | A-1 | A-1 | A-1 | A-10 |
| Pre-treatment fluid B | | | B-16 | B-17 | B-18 | B-1 |
| Ink | | | 1 | 1 | 1 | 1 |
| b/a | | | 0.12 | 0.12 | 0.12 | 0.12 |
| Attached amount of pre-treatment fluid A | | | 10 g/m² | 10 g/m² | 10 g/m² | 10 g/m² |
| Attached amount of pre-treatment fluid B | | | 10 g/m² | 10 g/m² | 10 g/m² | 10 g/m² |
| Evaluation | Coloring | | B | A | A | A |
| | Texture | | B | A | A | A |
| | Fastness | | A | A | A | A |
| | Storage | Pre- | A | A | A | A |
| | stability | treatment | | | | |
| | | fluid A | | | | |
| | | Pre- | A | A | A | A |
| | | treatment | | | | |
| | | fluid B | | | | |
| | Degradation | Pre- | A | A | A | A |
| | of Liquid | treatment | | | | |
| | Contact | fluid A | | | | |
| | Member | Pre- | A | A | A | A |
| | | treatment | | | | |
| | | fluid B | | | | |

TABLE 8

| | | | Comparative | Comparative | Comparative | Comparative |
|---|---|---|---|---|---|---|
| | | | Example 1 | Example 2 | Example 3 | Example 4 |
| Pre-treatment fluid A | | | A-4 | A-5 | A-6 | A-1 |
| Pre-treatment fluid B | | | B-1 | B-1 | B-1 | B-5 |
| Ink | | | 1 | 1 | 1 | 1 |
| b/a | | | 0.12 | 0.12 | 0.12 | 0.00 |
| Attached amount of pre-treatment fluid A | | | 10 g/m² | 10 g/m² | 10 g/m² | 10 g/m² |
| Attached amount of pre-treatment fluid B | | | 10 g/m² | 10 g/m² | 10 g/m² | 10 g/m² |
| Evaluation | Coloring | | A | A | A | A |
| | Texture | | C | A | A | A |
| | Fastness | | A | A | A | A |
| | Storage | Pre- | A | A | C | A |
| | stability | treatment | | | | |
| | | fluid A | | | | |
| | | Pre- | A | A | A | A |
| | | treatment | | | | |
| | | fluid B | | | | |
| | Degradation | Pre- | A | C | A | A |
| | of Liquid | treatment | | | | |
| | Contact | fluid A | | | | |
| | Member | Pre- | A | A | A | C |
| | | treatment | | | | |
| | | fluid B | | | | |
| | | | Comparative | Comparative | Comparative | Comparative |
| | | | Example 5 | Example 6 | Example 7 | Example 8 |
| Pre-treatment fluid A | | | A-1 | A-1 | A-1 | A-1 |
| Pre-treatment fluid B | | | B-6 | B-7 | B-8 | B-9 |
| Ink | | | 1 | 1 | 1 | 1 |
| b/a | | | 0.00 | 0.12 | 0.00 | 0.05 |
| Attached amount of pre-treatment fluid A | | | 10 g/m² | 10 g/m² | 10 g/m² | 10 g/m² |
| Attached amount of pre-treatment fluid B | | | 10 g/m² | 10 g/m² | 10 g/m² | 10 g/m² |
| Evaluation | Coloring | | A | — | — | A |
| | Texture | | A | — | — | A |
| | Fastness | | C | — | — | A |
| | Storage | Pre- | A | A | A | A |
| | stability | treatment | | | | |
| | | fluid A | | | | |
| | | Pre- | A | C | C | A |
| | | treatment | | | | |
| | | fluid B | | | | |
| | Degradation | Pre- | A | A | A | A |
| | of Liquid | treatment | | | | |
| | Contact | fluid A | | | | |
| | Member | Pre- | A | — | — | C |
| | | treatment | | | | |
| | | fluid B | | | | |

As seen in the results of Examples 1 to 24, the ink set of the present disclosure exhibits excellent storage stability and causes minimal degradation of the liquid contacting members in inkjet printing apparatuses. Furthermore, the use of this ink set enables reduction of deterioration in fabric texture when performing inkjet printing with aqueous pigment ink on fabric.

In contrast, as seen in the results of Comparative Examples 1 to 8, when an ink set outside the scope of the present disclosure is used, at least one of the following-fabric texture, fastness, storage stability, and degradation of liquid contacting member—is insufficient.

### Aspect 1

An ink set contains an aqueous pigment ink, a pre-treatment fluid A containing an amino-modified silicone, and a pre-treatment fluid B containing a water-soluble amine and an organic acid, wherein the following relationship is satisfied: 0.08≤b/a≤1.00, where a represents a total moles of acid groups of the organic acid in the pre-treatment fluid B and b represents a total moles of amino groups of the organic acid in the pre-treatment fluid B, and wherein the pre-treatment fluid A contains no organic acid.

### Aspect 2

The ink set according to the Aspect 1 mentioned above, wherein the organic acid in the pre-treatment fluid B contains at least one of lactic acid, citric acid, and acetic acid.

### Aspect 3

The ink set according to the Aspect 1 or 2 mentioned above, wherein the pre-treatment fluid B contains the organic acid in an amount of from 5 to 20 percent by mass.

### Aspect 4

The ink set according to any one of the Aspects 1 to 3 mentioned above, wherein the following relationship is satisfied: 0.08≤b/a≤0.30.

### Aspect 5

The ink set according to any one of the Aspects 1 to 4 mentioned above, wherein the water-soluble amine includes at least one member selected from the group consisting of 2-amino-2-methyl-1,3-propanediol (AMPD), 2-amino-2-ethyl-1,3-propanediol (AEPD), and triethanolamine.

### Aspect 6

The ink set according to any one of the Aspects 1 to 5 mentioned above, wherein the pre-treatment fluid A contains the amino-modified silicone in an amount of from 1 to 15 percent by mass.

### Aspect 7

A fluid applying method includes applying pre-treatment fluids containing separately the pre-treatment fluid A and the pre-treatment fluid B of the ink set of any one of the Aspects 1 to 6 to a substrate, and applying the aqueous pigment ink of the ink set of any one of the Aspects 1 to 6.

### Aspect 8

The method according to the Aspect 7 mentioned above, wherein the pre-treatment fluid A is applied before the pre-treatment fluid B.

### Aspect 9

The method according to the Aspect 7 or 8 mentioned above, further includes heat drying not between the applying the pre-treatment fluids and the applying the aqueous pigment ink.

### Aspect 10

The method according to any one of the Aspects 7 to 9 mentioned above, further includes pressing a region where at least one of the pre-treatment fluid A or the pre-treatment fluid B have been applied after the applying the pre-treatment fluids before the applying the aqueous pigment ink.

### Aspect 11

The method according to any one of the Aspects 7 to 10 mentioned above, wherein the applying the pre-treatment fluids includes changing an amount of the pre-treatment fluid A applied and an amount of the pre-treatment fluid B applied.

### Aspect 12

A fluid applying apparatus includes the ink set of any one of the Aspects 1 to 6, a pre-treatment fluid applying device to apply the pre-treatment fluid A and the pre-treatment fluid B to a substrate, and an ink applying device to apply the aqueous pigment ink.

### Aspect 13

The apparatus according to the Aspect 12 mentioned above, further includes a pressing device to press a region where at least one of the pre-treatment fluid A or the pre-treatment fluid B have been applied.

### Aspect 14

The apparatus according to the Aspect 12 or 13 mentioned above, further includes a surface cleaning device including a wiping member, wherein the pre-treatment fluid applying device includes a nozzle surface with nozzles that discharge the pre-treatment fluid A and with nozzles that discharge the pre-treatment fluid B,
wherein the ink applying device includes a nozzle surface with nozzles that discharge the aqueous pigment ink,
wherein the nozzle surface cleaning device cleans at least one of the nozzle surface of the pre-treatment fluid applying device or the nozzle surface of the ink applying device, and
wherein the wiping member wipes off fluid on at least one of the nozzle surface of the fluid applying device or the nozzle surface of the ink applying device.

### Aspect 15

The apparatus according to any one of the Aspects 12 to 14 mentioned above, further includes a mechanism to change an amount of the pre-treatment fluid A applied and an amount of the pre-treatment fluid B applied.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An ink set comprising:
an aqueous pigment ink;
a pre-treatment fluid A comprising an amino-modified silicone; and
a pre-treatment fluid B comprising a water-soluble amine and an organic acid, wherein the following relationship is satisfied:
$$0.08 \leq b / a \leq 1.00 ,$$
where a represents a total moles of acid groups of the organic acid in the pre-treatment fluid B and b represents a total moles of amino groups of the organic acid in the pre-treatment fluid B, and
wherein the pre-treatment fluid A contains no organic acid.

2. The ink set according to claim 1,
wherein the organic acid in the pre-treatment fluid B comprises at least one of lactic acid, citric acid, or acetic acid.

3. The ink set according to claim 1, wherein the pre-treatment fluid B contains the organic acid in an amount of from 5 to 20 percent by mass.

4. The ink set according to claim 1, wherein the following relationship is satisfied:
$$0.08 \leq b / a \leq 0.30 .$$

5. The ink set according to claim 1,
wherein the water-soluble amine includes at least one member selected from the group consisting of 2-amino-2-methyl-1,3-propanediol, 2-amino-2-ethyl-1,3-propanediol, and triethanolamine.

6. The ink set according to claim 1, wherein the pre-treatment fluid A contains the amino-modified silicone in an amount of from 1 to 15 percent by mass.

7. A fluid applying method comprising:
applying the pre-treatment fluids comprising separately the pre-treatment fluid A and the pre-treatment fluid B of the ink set of claim 1 to a substrate; and
applying the aqueous pigment ink of the ink set to the substrate.

8. The method according to claim 7,
wherein the applying the pre-treatment fluids includes:
applying the pre-treatment fluid A and then applying the pre-treatment fluid B.

9. The method according to claim 7, further comprising:
heat drying at least one of the pre-treatment fluid A, the pre-treatment fluid B, or the aqueous pigment ink, the heat drying not between the applying the pre-treatment fluids and the applying the aqueous pigment ink.

10. The method according to claim 7, further comprising:
pressing a region where at least one of the pre-treatment fluid A or the pre-treatment fluid B have been applied after the applying the pre-treatment fluids before the applying the aqueous pigment ink.

11. The method according to claim 7,
wherein the applying the pre-treatment fluids includes changing an amount of the pre-treatment fluid A applied and an amount of the pre-treatment fluid B applied.

12. A fluid applying apparatus comprising:
the ink set of claim 1;
a pre-treatment fluid applying device to apply the pre-treatment fluid A and the pre-treatment fluid B to a substrate; and
an ink applying device to apply the aqueous pigment ink.

13. The apparatus according to claim 12, further comprising a pressing device to press a region where at least one of the pre-treatment fluid A or the pre-treatment fluid B have been applied.

14. The apparatus according to claim 12, further comprising a nozzle surface cleaning device including a wiping member,
wherein the pre-treatment fluid applying device includes a nozzle surface with nozzles that discharge the pre-treatment fluid A and with nozzles that discharge the pre-treatment fluid B,
wherein the ink applying device includes a nozzle surface with nozzles that discharge the aqueous pigment ink,
wherein the nozzle surface cleaning device cleans at least one of the nozzle surface of the pre-treatment fluid applying device or the nozzle surface of the ink applying device, and
wherein the wiping member wipes off fluid on at least one of the nozzle surface of the fluid applying device or the nozzle surface of the ink applying device.

15. The apparatus according to claim 12, further comprising a mechanism to change an amount of the pre-treatment fluid A applied and an amount of the pre-treatment fluid B applied.
